(19) United States
(12) Patent Application Publication
(10) Pub. No.: US 2015/0009331 A1
(43) Pub. Date: Jan. 8, 2015

(54) REAL TIME RAILWAY DISASTER VULNERABILITY ASSESSMENT AND RESCUE GUIDANCE SYSTEM USING MULTI-LAYERED VIDEO COMPUTATIONAL ANALYTICS

(71) Applicant: Balaji VENKATRAMAN, Bangalore (IN)

(72) Inventor: Balaji Venkatraman, Bangalore (IN)

(21) Appl. No.: 14/378,326

(22) PCT Filed: Feb. 12, 2013
(86) PCT No.: PCT/IB2013/051126

§ 371 Date: Aug. 13, 2014

(30) Foreign Application Priority Data
Feb. 17, 2012 (IN) 595/CHE/2012

(51) Int. Cl. B61L 23/04; H04N 7/18; B61L 27/00

(52) U.S. Cl. CPC B61L 23/041; B61L 23/042; B61L 27/0088; H04N 7/181; B61L 15/0027
USPC 348/148

(57) ABSTRACT

The system for real time train disaster vulnerability assessment and rescue guidance using multi layered video computational analytics comprises digital video cameras mounted on train, video cameras mounted at fixed locations on rail route; unmanned aerial monitoring vehicle; train on-broad computer system mounted on train and centralized system centrally located in railway network. The digital video cameras capture video images of railways track and adjacent structure from running train and automatically compute degree of disaster vulnerability from collective analysis of output from all video cameras. In case degree of disaster vulnerability exceeds predetermined threshold value a disaster alert is triggered to take immediate precautionary measures while simultaneously activating On Board Rescue and Response System. In case degree of disaster vulnerability is below predetermined threshold value, the analytics output is transmitted to higher level modules for in-depth advanced analytics by combining real-time train data or real-time geographic and environmental data contributing to a potential disaster.

### CROSS REFERENCE TO RELATED APPLICATION

The present application is a U.S. national stage application (under 35 USC §§371) of PCT international application PCT/IB2013/051126 having an international filing date of 12 Feb. 2013, which claims priority from Indian provisional application numbered 595/CHE/2012 filed with Indian patent Office, Chennai on 17 Feb. 2012.

### TECHNICAL FIELD OF THE INVENTION

The invention relates to a system for real time rail disaster vulnerability assessment and rescue guidance using multi layered video computational analytics and artificial neural network, fuzzy logic and expert systems. In particular, the invention provides a system for predicting and preempting a disaster by making real time assessment of a potential disaster and in case of a disaster, the system ensures minimal or nil damage to the train systems as well as occupants inside the train as well as the others train systems and occupants by employing a suitable onboard rescue and recovery system based on the disaster vulnerability profile of the passengers inside and the outside of the train.

### BACKGROUND OF THE INVENTION

Railway Network is an essential and important national infrastructure and plays a key role in the economic development of a country. The railways infrastructure is used more and more as a conveyance medium as well as a medium for movement of goods. Since trains comprise a large number of bogies and carry massive number of passenger and cargo and the distances and terrains traversed by trains are spread across huge geographical areas, trains are particularly highly vulnerable and highly prone to various kinds of disasters. In the current scenario more and more people and goods move to a larger distances at a rapid rate than any of our earlier human generations in the history. Hence the vulnerabilities have increased multifold resulting in frequent train accidents due to various causes ranging from fires, natural calamities, terrorist attacks etc. The other most common causes of train accidents are related to abnormalities in railway tracks resulting to train derailments, road bed abnormalities, weakened or collapsed bridges, signaling errors or at times collisions due to signaling failures. Some other causes of such accidents may be due to unsynchronized railway signal and communication, mechanical and electrical failures in the railway systems. Accidents may also happen due to collision with foreign objects, contact with explosive device causing serious damage to goods and human life. Since railway infrastructure is wide open, unprotected and spreads across vast geographical regions, it becomes impossible at times to carry out close and detailed monitoring of railway infrastructure for maintenance, reliability and operational safety at all times. Also the cost of monitoring the large railway infrastructure which covers all regions of the large country becomes quite expensive and infeasible at times due to shortage of skilled manpower and technical resources and also costs associated with such huge activity. A number of devices and methods are available in prior art that can extract defects in the railway track, rail bed and joints etc. One of the main shortcomings of the existing prior arts is that they only provide solutions based on the assessment of the defects or abnormalities on individual component basis such as capturing video images of the track separately, comparing images with stored images and generating an alert signal to notify the presence of the irregularity that meets a pre-selected criterion specific to the particular component. Even though prior arts address some level of train inspections at individual component level using video image capture, these systems fail to provide a comprehensive integrated disaster avoidance solution based on the collective analysis of the multiple defects and other external situational factors such as geographical, climatic and environmental factors that when taken into consideration all at once, may cause greater level of disaster impact to the train and occupants than anticipated by considering the separate defect factor alone. For example, a railway track defect related to gauge as a individual disaster assessment may have very low disaster vulnerability but when the same gauge defect is taken in the context of a railway track over a bridge or a high mountain valley with a train running at a speed of 160 km per hour may be serious train disaster vulnerability due to combined consideration of all the above factors.

Another major concern during an emergency or disaster situation is the application of appropriate rescue and response operation based on the disaster vulnerability of occupants inside the train. Conventionally the rescue measures taken by disaster management systems are applied generically to all the occupants irrespective of their age, medical/physical condition of the passenger, location of the passenger to the nearest exit, total number of compartments, or speed of the train. All these factors play a major role in estimating the disaster vulnerability of the individual passengers inside the train since a person younger in age is more active in rescuing himself as well as other fellow members whereas as an old person or a small child need more attention and timely rescue or safety measures during emergency. There is no such rescue and response system available today that can apply appropriate rescue measure depending upon the rescue vulnerability of a passenger.

Various attempts have been made to avoid or reduce the impact of the accidents by various systems and methods but no system is available till today that makes real time assessment of a potential disaster using collective output of various factors contributing to a disaster and also reduces the impact of disaster by applying a suitable and context sensitive rescue system based on the disaster vulnerability of the occupant inside the train and as well as people outside the train. It is therefore desirable to provide effective systems for achieving above results effectively and avoid or reduce the damage caused by taking timely and suitable measures. Also there is no existing system today, which shall have multiple levels of disaster vulnerability assessment based on various static and dynamic factors. There also no disaster vulnerability assessment system existing today which shall have inter train communication in order to pass on various critical disaster related information which shall reduce the possibility of a disaster.

### SUMMARY OF THE INVENTION

The present overcomes the problems in the prior art by providing system for real time rail disaster vulnerability assessment and rescue guidance using multi-layered video computational analytics.

The system comprises Digital Video Camera System having plurality of high speed digital video cameras mounted on train for measurement, computation and preliminary analytics of rail track features and adjacent structure; plurality of stationary digital video cameras mounted at fixed locations on railway bridges, railway tunnels, railway towers and railway adjacent structure for monitoring and analyzing the railway track and systems from fixed location; plurality of unmanned aerial monitoring vehicle; plurality of digital video cameras mounted on aerial monitoring vehicle for measurement, computation and preliminary analytics of rail track features and adjacent structure of rail route using embedded computational video analytics, image processing and artificial neural networks. The Digital Video Camera System automatically computes degree of disaster vulnerability from collective analysis of output from said video cameras and in case degree of disaster vulnerability exceeds predetermined threshold value, the system triggers a preliminary disaster alert to a Preliminary Automatic Emergency Control System inside the train to take immediate precautionary measures to avoid potential disaster while simultaneously activating On Board Rescue and Response System and in case degree of disaster vulnerability is below the predetermined threshold value.

The preliminary analytics output is transmitted to train on board computer system for in-depth advanced analytics whereby avoiding the damage to train and occupants and considerably reducing the rescue response time by immediately activating rescue and response system and also transmitting disaster alerts for further confirmation from advanced systems in the network.

The system includes a Train Onboard Computer System mounted inside each train. The Train Onboard Computer System has plurality of high speed computing devices for performing comprehensive and deeper level of advanced analytics using the preliminary analytics output from Digital Video Camera System and the real-time train data contributing to a potential disaster. The Train Onboard Computer system automatically computes degree of disaster vulnerability from collective analysis of output from said Digital Video Camera System and in case degree of disaster vulnerability exceeds predetermined threshold value, the system triggers an advanced disaster alert to a Advanced Automatic Emergency Control System inside the train to take immediate precautionary measures to avoid potential disaster while simultaneously activating On Board Rescue and Response System. In case degree of disaster vulnerability is below the predetermined threshold value, the advanced analytics output is transmitted to train on board computer system for more detailed centralized analytics whereby performing collective analysis of an abnormality by taking into consideration train related factors as well as historical information of the train from the stored databases contributing to a disaster.

The system also includes a Central Command Control Computation System located at a central location in the railway network and is connected to said Train Onboard Computer System inside the trains in said railway network via communication network, said Central Command Control Computation System having plurality of network connected high speed computing devices configured to perform more detailed centralized analytics using collective output received from Train Onboard Computer System and the real-time geographic and environmental data contributing to a potential disaster. The Central Command Control Computation System automatically calculates the degree of disaster vulnerability based on said collective output and triggers a centralized disaster alert to the operator of the train of the risk of an accident involving said train in case degree of disaster vulnerability exceeds threshold value, said Central Command Control Computation System also activates on board rescue and response system upon detecting a serious disaster whereby performing collective analysis of an abnormality by taking into consideration geographic and environmental data contributing to a potential disaster.

The invention provides an intelligent and effective system for predicting and preempting a disaster by making real time assessment of a potential disaster. In case the disaster takes place, the system ensures minimal damage to the train as well as occupants inside the train and outside the train by using by application of a suitable onboard rescue and recovery system based on the disaster vulnerability profile of the passengers inside the train and reduces the damage caused by taking timely and suitable measures.

### BRIEF DESCRIPTION OF THE DRAWINGS

FIG. 1 illustrates a block diagram of the real time rail disaster vulnerability assessment and rescue guidance system using multi layered video computational analytics in accordance with one embodiment of the invention.

FIG. 2 illustrates the schematic layout of the real time rail disaster vulnerability assessment and rescue guidance system using multi layered video computational analytics in accordance with one embodiment of the invention.

FIG. 3 illustrates a block diagram of the Communication Network according to one embodiment of the invention.

FIG. 4 illustrates block diagram of the Digital Video Camera System in accordance with one embodiment of the invention.

FIG. 5 illustrates a block diagram of the Train Onboard Computer System in accordance with one embodiment of the invention.

FIG. 6 illustrates a block diagram of the Central Command Control Computation System in accordance with one embodiment of the invention.

FIG. 7 illustrates the analytical model for real time rail disaster vulnerability assessment and rescue guidance using multi layered video computational analytics in accordance with one embodiment of the invention.

FIG. 8 illustrates the analytical model for real time rail disaster vulnerability assessment and rescue guidance using multi layered video computational analytics in accordance with one embodiment of the invention.

FIG. 9a illustrates the method of real time rail disaster vulnerability assessment and rescue guidance using multi layered video computational analytics in accordance with one embodiment of the invention.

FIG. 9b illustrates the method of real time rail disaster vulnerability assessment and rescue guidance using multi layered video computational analytics in accordance with one embodiment of the invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The system for real time train disaster vulnerability assessment and rescue guidance using multi layered video computational analytics comprises digital video cameras mounted on train, video cameras mounted at fixed locations on rail route; unmanned aerial monitoring vehicles; train on broad computer system mounted on train and centralized system centrally located in railway network. The digital video cameras capture, measure and analyzes video images of railways track and adjacent structure from a running train and automatically compute degree of disaster vulnerability from collective analysis of output from all video cameras. In case degree of disaster vulnerability exceeds predetermined threshold value a disaster alert is triggered to take immediate precautionary measures while simultaneously activating On Board Rescue and Response System. In case degree of disaster vulnerability is below predetermined threshold value, the analytics output is transmitted to higher level modules for in-depth advanced analytics by combining real-time train data and real-time geographic and environmental data contributing to a potential disaster. The invention provides an intelligent and effective system for avoiding a disaster or reducing the disaster impact by making real time assessment of a potential disaster. In case the disaster takes place, the system ensures minimal damage to the train as well as occupants inside the train and outside the train by using by application of a suitable onboard rescue and recovery system based on the disaster vulnerability profile of the passengers inside the train and reduces the damage caused by taking timely and suitable measures.

The present invention includes a plurality of sub systems comprising computing and analytic components with various levels of functionalities based on the real time response requirements, static and dynamic information requirements, computing power requirements and additional situational factors and variables related to rail network operating environment. The invention is based up on history of accidents and disasters taken place in the railway tracks. The invention mainly focused on all types of railway track, railway track structures and systems.

Although the present invention will be described with reference to its application to railways it will be appreciated by person skilled in the art that the invention has applications for other surface and vertical transport vehicle as well that run on Railway tracks such as Metro Train, Trams etc.

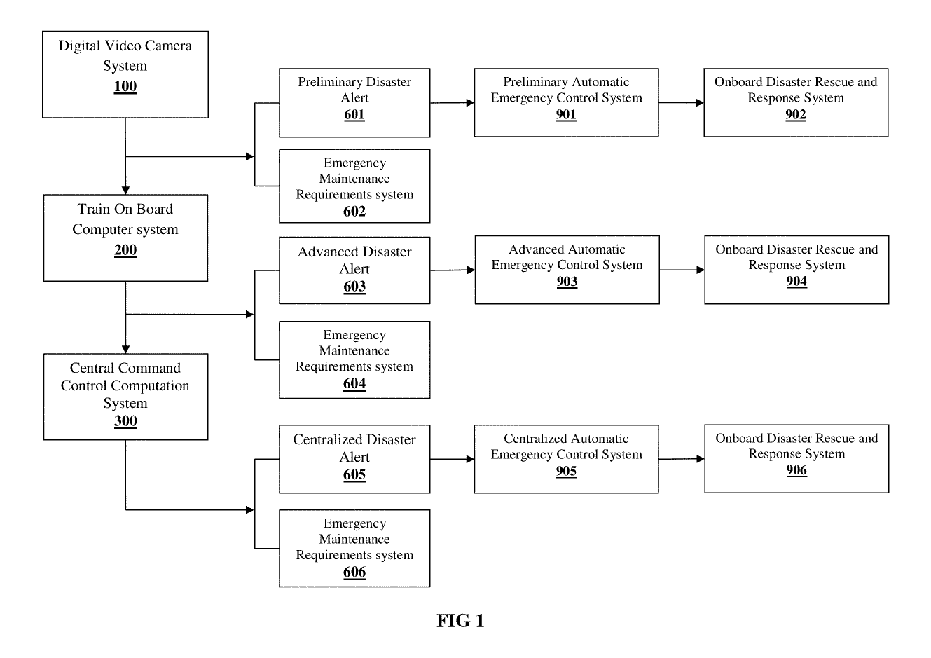

FIG. 1 illustrates a block diagram of the real time rail disaster vulnerability assessment and rescue guidance system using video computational analytics in accordance with one embodiment of the invention. The system is illustrated as a block diagram and includes various sub systems for performing detailed video analytics. The sub system comprises Digital Video Camera System (100), Train onboard Computer System (200), Central Command Control Computation System (300) and Stationary Video Camera System (400). The system may optionally include high speed digital video camera mounted on unmanned aerial monitoring vehicle for capturing, measuring, computation and performing preliminary analytics of railway track features and adjacent structure using embedded computational video analytics, image processing and artificial neural networks. The system is designed to automatically perform various analytics at each layer in hierarchical order with feedback learning loop, based on the output received from a lower level sub-system and trigger the disaster alert at each layer. Based on the degree of disaster vulnerability, the output is confirmed by the advanced analytics and is finally confirmed with the central command control computation system (300) in order to ensure the high degree of accuracy in the disaster vulnerability assessment.

The Digital Video Camera System (100) comprises plurality of high speed digital video cameras mounted at various locations on the train and also includes high speed digital video cameras mounted on the railway bridges, railway tunnels, railway towers or any other railway adjacent structure for the purpose of monitoring and analyzing the railway track and systems from a fixed location. The Digital Video Camera System (100) is configured to capture, measure and analyze continuous and discrete video images of the railway tracks and other adjacent components such as railway beds and foundations systems, railway track adjacent environment and other adjacent geographical features while the train is running by using plurality of high speed video cameras mounted on the train. The video cameras in the Digital Video Camera System (100) also have embedded analytic modules inside to perform preliminary analytics on the video images analyzed by the Digital Video Camera System (100). One of the main advantages of the Digital Video Camera System (100) is that this module senses preliminary defects in the rail track (if any) and automatically computes degree of disaster vulnerability from collective analysis of output from the video cameras. In case in case degree of disaster vulnerability exceeds predetermined threshold value, the system triggers Preliminary Disaster Alert (601) to the Preliminary Automatic Emergency Control System (901) which immediately takes necessary precautionary measures to avoid the potential accident or disaster and also activates various Onboard Disaster Rescue and Recovery System (902) in order to reduce the impact of the accident on the occupants. The system also transmits potential disaster scenarios with associated impacts immediately to other respective network connected trains that are about to come from opposite direction from a different rail track or to the train that is about to pass through same rail track in future whereby avoiding further damage by trains passing through disaster prone railway track segment location. The preliminary analytics also includes Preliminary Emergency Maintenance Analytics (113) in case the system detects any abnormalities in the Rail Track for rectification of the abnormality. Since, Digital Video Camera System (100) doesn't have other important data available with it such as data about previous trains, and various factors that may cause a train disaster. Hence in case the degree of disaster vulnerability is below the predetermined threshold value, output from preliminary analytics is sent for in-depth advanced analytics to the Train Onboard Computer System (200) that performs collective analysis by combining other important factors that may affect the disaster vulnerability of the train. The Digital Video Camera System (100) avoids damage to train and occupants and considerably reduces the rescue response time by immediately activating rescue and response system and also transmitting disaster alerts for further confirmation from advanced systems in the network.

The Train Onboard Computer System (200) is located inside a compartment of the train and comprises high speed computing devices having real time network connection with the Digital Video Camera System (100) via real time communication network. The Train Onboard Computer System (200) has various database records stored inside the server and various other analytics functions and methods that compute disaster vulnerability of the train by using neural network. The Train Onboard Computer System (200) receives output from the preliminary analytics performed by the embedded analytics module in the Digital Video Camera System (100) and performs comprehensive and deeper level of advanced analytics by using real-time train data contributing to a potential disaster. The real-time train data maintained by Train Onboard Computer System (200) comprises train speed, vibration in the train, number of compartments in the train, maintenance status of the train, railway segment profile, data from previous train runs and historical information from the stored database for considering train related factors contributing to an accident or disaster in addition to track related abnormalities. Based on the collective analysis of the above factors a train disaster vulnerability profile is created and based on the vulnerability of the passengers, a passenger disaster vulnerability profile is created. The system automatically computes the degree of disaster vulnerability from collective analysis of output from the Digital Video Camera System (100), train disaster vulnerability profile and passenger disaster vulnerability profile. The system triggers an advanced disaster alert (603) in case the degree of disaster vulnerability exceeds a predetermined threshold value. The Advanced Automatic Emergency Control System (903) immediately takes necessary precautionary measures to avoid the potential accident or disaster. The Advanced Automatic Emergency Control System (903) may also activate various Onboard Disaster Rescue and Recovery System (904) in order to reduce the impact of the accident on the occupants. The system also transmits potential disaster scenarios with associated impacts immediately to other respective network connected trains that are about to come from opposite direction from a different rail track or to the train that is about to pass through same rail track in future whereby avoiding further damage by trains passing through disaster prone railway track segment location. The advanced analytics also transmits information to Emergency Maintenance Requirement system (604) of the railway track in case it detects any abnormalities in the rail track the rail track after advanced analytics for rectification of the abnormality. In case the degree of disaster vulnerability is below the predetermined threshold value, output from advanced analytics is sent for further analysis to the Central Command Control Computation System (300) for performing for more detailed centralized analytics that aggregates various other factors that may affect the disaster vulnerability of the train.

The Central Command Control Computation System (300) is located at a central location in the train network and is connected to the Digital Video Camera System (100) and Train Onboard Computer System (200) mounted on each train via communication network. The Central Command Control Computation System (300) that receives the latest data performs centralized analytics using real time data from all other trains and centralized databases of all the previous trains runs across various railway routes in the railway network. The Central Command Control Computation System (300) comprises high speed computing machines and wide area computer communication infrastructures which are configured to collect and analyze various track videos and track analytics data and operational, maintenance and environmental information received from Digital Video Camera System (100) and Train Onboard Computer System (200) for centralized processing and analytics. The Central Command Control Computation System (300) has access to real-time geographical and environmental data of the rail route. The real-time geographical and environmental data comprises real time geographic features of the area the train is passing through and real time environmental factors prevailing in a particular rail route whereby combining environmental factors as well as geographical factors to advanced analytics output that may contribute to a potential disaster and subsequently taking necessary precautionary measures to avoid such disaster. The real-time geographical and environmental data may also include information about other trains running on the same route to avoid any potential collision, real time geographic features such as existence of mountain range that increase the train vulnerability, climatic and environmental factors such as rain, storm, wind speed, existence of deep valley or mountain range and also previous records/analytics outputs from the other trains. The Central Command Control Computation System (300) receives output from the advanced analytics performed by the Train Onboard Computer System (200) and based on the collective output of the above factors, a train disaster vulnerability profile is created and based on the vulnerability of the passengers; a passenger disaster vulnerability profile is created.

The Central Command Control Computation System (300) computes a final train disaster vulnerability profile by aggregating the output received from Train Onboard Computer System (200) and the output received from Central Command Control Computation System (300) along with real-time geographic and environmental data contributing to a potential disaster. The system triggers a Centralized Disaster Alert (605) in case the degree of disaster vulnerability exceeds a predetermined threshold value and the Centralized Automatic Emergency Control System (905) immediately takes necessary precautionary measures to avoid the potential accident or disaster. The Centralized Automatic Emergency Control System (905) may also activate Onboard Disaster Rescue and Recovery System (906) in order to reduce the impact of the accident on the occupants. The system also transmits potential disaster scenarios with associated impacts immediately to other respective network connected trains that are about to come from opposite direction from a different rail track or to the train that is about to pass through same rail track in future whereby avoiding further damage by trains passing through disaster prone railway track segment location. The advanced analytics also transmits information to Emergency Maintenance Requirement system (606) of the railway track in case it detects any abnormalities in the Rail Track after centralized analytics for rectification of the abnormality.

All the above sub systems communicate with each other via communication network that establishes network connectivity among them. The communication network comprises various computing and networking devices that transmit and receive data in real time and non real time via various wide area communication technologies such as communication satellites, 3G, radio communication networks, Wi-Fi etc.

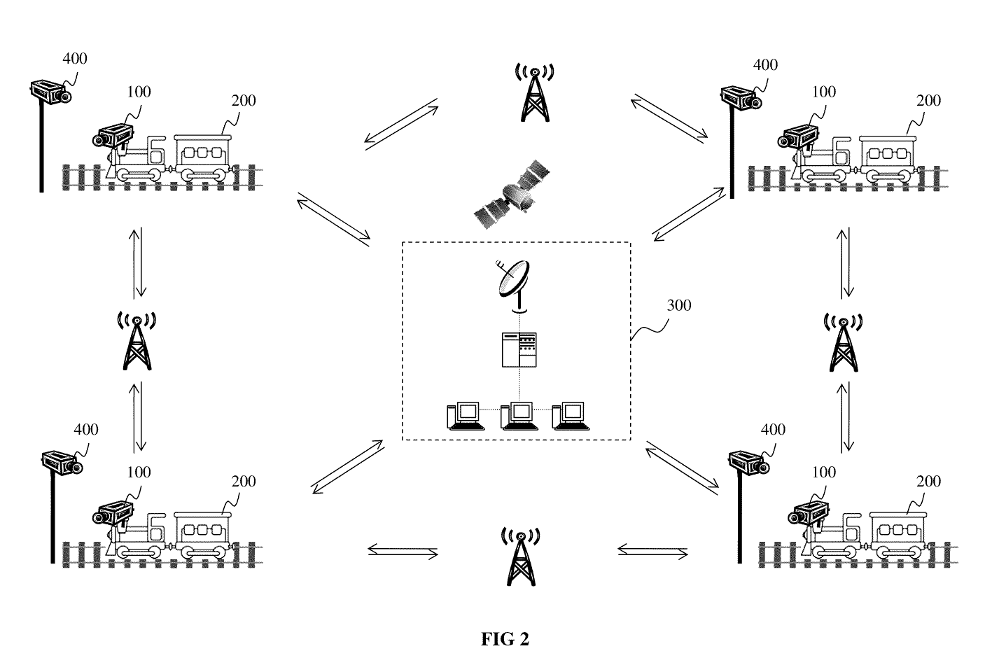

FIG. 2 illustrates the schematic layout of the real time rail disaster vulnerability assessment and rescue guidance system using video computational analytics in accordance with one embodiment of the invention. The system includes various sub systems for performing detailed video analytics comprising Digital Video Camera System (100), Train onboard Computer System (200), and Central Command Control Computation System (300), Stationary Video Camera System (400) and unmanned aerial monitoring vehicle (not shown in Figure) for capturing, measuring, computation and performing preliminary analytics of railway track features and adjacent structure using embedded computational video analytics, image processing and artificial neural networks. The Train onboard Computer System (200) in each train is connected to the Train onboard Computer System (200), on the other train via wireless communication network. The Train onboard Computer System (200) in each train is further connected to a Central Command Control Computation System (300) via wireless communication network.

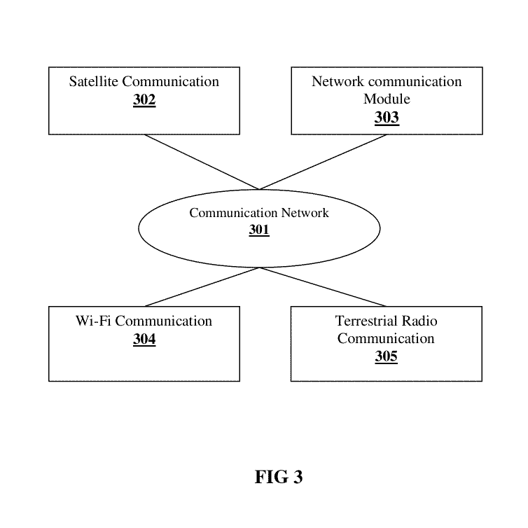

FIG. 3 illustrates a block diagram of the Communication Network according to one embodiment of the invention. In order to exchange various types of data and information among rest of the systems mounted on other trains in the real time rail disaster vulnerability assessment system network, the system uses a Communication Network (301) that may comprise at least one of Onboard Satellite Communication Module (302), Network Communication Module (303), Wi-Fi communication module (304) or Terrestrial Radio Communication Module (305). The Onboard Satellite Communication Module (302) mainly transmits and receives information in real time among Train Onboard Computer System (200) mounted on other trains in the network, using satellite communications. The Network Communication Module (303) may comprise any one of GSM (Global System for Mobile), CDMA (Code division multiple access), WI-Max (Worldwide Interoperability for Microwave Access) or OFDM (Orthogonal frequency-division multiplexing) Communication System or any other communication technology for wirelessly delivering data at high-speed to large geographical areas. The Network Communication Module (303) mainly transmits and receives information in real time to and from various train systems via Central Command Control Operations Center. The Wide Area Communication System (301) may also includes onboard Wi-Fi communication module (304) mainly to transmit and receive information in real time using WIFI communications system among various other systems installed in other railway Track Monitoring systems via Central Command Control Operations Center. The Terrestrial Radio Communication Module (305) transmits and receives information in real time using Terrestrial Radio communications while moving among various train systems via Central Command Control Operations Center. The communication system is adapted to establish communication among all the modules in the invented system.

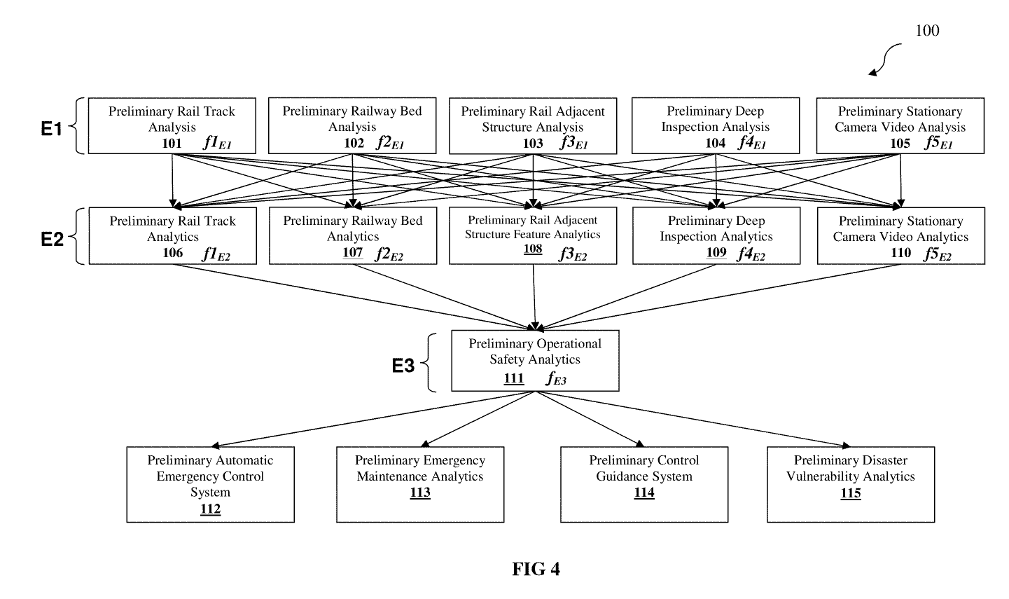

FIG. 4 illustrates block diagram of the Digital Video Camera System in accordance with one embodiment of the invention. The Digital Video Camera System (100) comprises plurality of high speed digital video cameras mounted at various locations on the train, based on the specific objective of the video analytics. All the video cameras used in the system are digital IP cameras (also called as network camera with an IP network connection) having inbuilt microprocessors, data storage, input and output interfaces and primary and secondary memory and various communication interfaces for exchange of data among various other modules in the system. Video cameras used in the system have standard specifications such as 360 degree pan, adjustable tilt, auto flip, auto zoom, high resolution, adjustable range of capture, adjustable focal length, image capture intensity, zooming performance etc. Optionally for night illumination, infra red cameras may also be used to illuminate badly lit areas inside a tunnel, under a shady area or during night time. The video cameras used in the system may be customized to automatically perform the above functions based on the analytics performed by the system. In any train, there may be multiple sets of railway track video camera units mounted at appropriate locations on a train.

The video cameras in Digital Video Camera System (100) are configured to capture real time video images of railway track system and other components such as railway beds and foundations systems, railway track adjacent environment and geographical features. The videos and images captured from the running train are processed to create multiple copies of images based on the feature extraction requirements for embedded Analytics components. The Digital Video Camera System (100) comprises at least three layers for capturing the video images, processing and performing analytics on the captured video images. The first layer (E1) of the Digital Video Camera System (100) comprises plurality of video cameras for performing Preliminary Rail Track Analysis f1_{E1} (101), Preliminary Rail Bed feature Analysis f2_{E1} (102), Preliminary Adjacent Structure Analysis f3_{E1} (103) and Preliminary Deep Inspection Analysis f4_{E1} (104). All the video cameras are mounted at optimal positions on the train so as to capture real time videos and images of different segments of the rail track providing different levels of detail based upon its proximity with the railway track and the field of view (FOV) of the video camera. The system also includes plurality of Preliminary Stationary Video Camera Video Analysis f5_{E1} (105) system comprising high speed digital video camera fixed at predefined locations on the railway bridges, railway tunnels, railway towers or any other railway adjacent structure for the purpose of monitoring and analyzing the railway track and systems. System may also use unmanned aerial monitoring vehicle (not shown in Figure) for capturing, measuring, computation and performing preliminary analytics of railway track features and adjacent structure using embedded computational video analytics, image processing and artificial neural networks.

The video cameras used for Preliminary Railway Track Analysis f1_{E1} (101) are mounted on the front portion of the train to capture videos of the rail track in front of the engine to capture real time video for deep inspection and investigation of the track and to perform structure feature extraction of the rail track. This module captures any discontinuity in the rail track and also performs track breakage prediction to monitor any breakage in the railway track from a distance from a running train to avoid any accident. This module evaluates various engineering, technical, operational measures against the standard specifications and acceptable limits. This module captures images of various critical portions of the railway track and performs the railway track geometry feature analysis, railway track structure feature analysis, railway track curvature feature analysis, railway track level feature analysis, railway track obstruction feature analysis, railway track static obstruction feature analysis, railway track dynamic obstruction feature analysis, railway track stationary collision object feature analysis and railway track dynamic collision object feature analysis to detect any abnormality in any of these. The video images provided by the video camera in the system may also be used to perform track turnout analysis to monitor turnout points of the railway tracks. A turnout point is a mechanical installation enabling railway trains to be guided from one track to another at a railway junction. The images may further be used to perform track position profile analysis and track ballast analysis. This module also various other railway track measurements such as gauge measurements, cross level measurements, twist over a preset base and rail top, measurement of flange way gap, clearance between left hand rails and switch blade or check rail and clearance between right hand rails and switch blade or check rail, rail straightness gauge, rail head profile gauge, switch X-Y profile measurement, vehicle ride performance, comfort monitoring and track conditions on board in-service, embedded rails in urban transport systems and rail/road crossings, rail height, keeper rail height compared to the surrounding infill material for maintenance and safety monitoring, railhead against referenced stops for both standard and grooved rails.

The video cameras used for Preliminary Railway Bed Analysis f2_{E1} (102) captures high definition images or videos of the railway bed and foundation systems and other associated structures such as sleeps, ballast etc that need a closer monitoring and maintenance. The video cameras in this system are mounted preferably at a suitable angle on the train to capture images of a portion of the rail track slightly closer to the area captured by the video camera for Preliminary Rail Track Analysis f1_{E1} (101). This module evaluates various engineering, technical, operational measures against the standard specifications and acceptable limits. The video cameras in this module analyze various features of the railway bed and perform measurements on railway bed geometry features, railway bed rails foundation, railway bed formation, railway bed ballast, railway bed formation, railway bed geometrics, railway bed shoulder and railway bed track foundation to detect any abnormality in the railway bed components.

The video cameras used for Preliminary Rail Adjacent Structure Analysis f3_{E1} (103) capture high definition images or videos of the structures adjacent to the railway track that may cause an obstruction to the regular operation of the train while passing through such track. The adjacent structure and associated structures may include structures such as adjacent track lines, signal posts, building walls, bridge walls, tunnel walls etc. The module evaluates various engineering, technical, operational measures against the standard specifications and acceptable limits. This module performs rail adjacent structure measurements that include various image processing functions such as railway bridges geometrics feature analysis, railway tunnel geometrics feature analysis, railway high mountain geometrics feature analysis, railway adjacent stationary object feature analysis, railway adjacent moving object feature analysis, adjacent train relative velocity feature analysis, adjacent train relative acceleration feature analysis, adjacent track geometrics feature analysis, railway adjacent environment feature, railway adjacent geographic feature analysis, railway adjacent structure feature analysis and railway climatic features analysis.

The video cameras used for Preliminary Deep Inspection Analysis f4_{E1} (104) capture more detailed high definition images and videos of the railway track components such as track joints, joint welding, pivoting, sleepers, rail surface etc. The module evaluates various engineering, technical, operational measures against the standard specifications and acceptable limits. This module detects any preliminary defects in the railway earthwork movements, cracks and defective sleepers, cracks and defective railway track railway drainage systems, railway cracks and defective switching levers, cracks and defective railway bridge holdings, cracks and defects in railway bridges, cracks and defective railway tunnels, track corrosion, cracks and defective welding systems, soil movements and water detection etc. The video cameras used for Preliminary Deep inspection Analysis f4_{E1} (104) performs image processing functions such as railway track joints feature analysis, railway wielding feature analysis, railway track surface images feature analysis and railway earthwork features analysis.

The system also includes plurality of Preliminary Stationary Video Camera Video Analysis f5_{E1} (105) comprising high speed digital video camera fixed at predefined locations on railway bridges, railway tunnels, railway towers or any other railway adjacent structure from a fixed location for the purpose of monitoring and analyzing the railway track and systems. The video cameras in this system are installed in such a way that they can capture video images of a large segment of the track and adjacent structure and can send an alert in case it detects any abnormality. (The Preliminary Unmanned Aerial Monitoring Vehicle is not shown in Figure)

All the outputs of the preliminary analysis by the video cameras in the first layer (E1) are sent as input signal to the second layer (E2) via artificial neural network to perform preliminary analytics on the input received. Neural networks are very sophisticated non-linear modeling techniques capable of modeling extremely complex functions. Each output received from the first layer (E1) is assigned a weight or strength at second layer (E2) so as to compute the disaster vulnerability of the train based on the various combinations from different modules in the first layer (E1) using artificial neural networks.

In one embodiment, the output vector at first layer (E1) may be computed using the following formula:

a1_{E1}=f1_{E1}(P1_{E1}×[W1_{E1}*Z1_{E1}]+B1_{E1})

a2_{E1}=f2_{E1}(P2_{E1}×[W2_{E1}*Z2_{E1}]+B2_{E1})

a3_{E1}=f3_{E1}(P3_{E1}×[W3_{E1}*Z3_{E1}]+B3_{E1})

a4_{E1}=f4_{E1}(P4_{E1}×[W4_{E1}*Z4_{E1}]+B4_{E1})

a5_{E1}=f5_{E1}(P5_{E1}×[W5_{E1}*Z5_{E1}]+B5_{E1})

where
Output Vector (ai_{E1}):

a1_{E1} is the output vector from system f1_{E1}

a2_{E1} is the output vector from system f2_{E1}

a3_{E1} is the output vector from system f3_{E1}

a4_{E1} is the output vector from system f4_{E1}

a5_{E1} is the output vector from system f5_{E1},

### Input Vector (Pi_{E1}):

P1_{E1} is the input vector for system f1_{E1}

P2_{E1} is the input vector for system f2_{E1}

P3_{E1} is the input vector for system f3_{E1}

P4_{E1} is the input vector for system f4_{E1}

P5_{E1} is the input vector for system f5_{E1},

where input vector contains the values assigned to the video captured by the video cameras in first layer (E1)

### Weight Matrix (Wi_{E1}):

W1_{E1} is the weight scalar for system f1_{E1}

W2_{E1} is the weight scalar for system f2_{E1}

W3_{E1} is the weight scalar for system f3_{E1}

W4_{E1} is the weight scalar for system f4_{E1}

W5_{E1} is the weight scalar for system f5_{E1}

where weight scalar is the value of the weight assigned to each input from the video captured by the video cameras in first layer (E1) depending upon the depth of the defect detected by the input vector.

### Bias Vector (Bi_{E1}):

B1_{E1} is the Bias for system f1_{E1}

B2_{E1} is the Bias for system f2_{E1}

B3_{E1} is the Bias for system f3_{E1}

B4_{E1} is the Bias for system f4_{E1}

B5_{E1} is the Bias for system f5_{E1}

where bias is the average error that a particular model training procedure makes across different particular data sets (drawn from the unknown function's distribution). The variance reflects the sensitivity of the modeling procedure to a particular choice of data set.

### Error Adjustment Factor for Back Propagation (Zi_{E1}):

Z1_{E1} is the Error Adjustment Factor for system f1_{E1}

Z2_{E1} is the Error Adjustment Factor for system f2_{E1}

Z3_{E1} is the Error Adjustment Factor for system f3_{E1}

Z4_{E1} is the Error Adjustment Factor for system f4_{E1}

Z5_{E1} is the Error Adjustment Factor for system f5_{E1}

where the Error Adjustment Factor uses the data to adjust the network's weights and thresholds so as to minimize the error in its predictions on the training set. If the network is properly trained, it has then learned to model the (unknown) function that relates the input variables to the output variables, and can subsequently be used to make predictions where the output is not known.

Once the number of layers and number of units in each layer has been selected, the networks weights and thresholds must be set so as to minimize the prediction error made by the network. This is the role of the training algorithms. The historical cases that have been gathered are used to automatically adjust the weights and thresholds in order to minimize this error. The error of a particular configuration of the network can be determined by running all the training cases through the network, comparing the actual output generated with the desired or target outputs. The differences are combined together by an error function to give the network error. The most common error functions are the sum squared error (used for regression problems), where the individual errors of output units on each case are squared and summed together, and the cross entropy functions (used for maximum likelihood classification).

The output vector (a1_{E1}, a2_{E1}, a3_{E1}, a4_{E1}, a5_{E1}) from the modules f1_{E1}, f2_{E1}, f3_{E1}, f4_{E1} and f5_{E1} respectively on the first layer (E1), is passed as input vector (p1_{E1}, p2_{E1}, p3_{E1}, p4_{E1}, and p5_{E1}) to the second layer (E2) which is an embedded analytics layer inside each of the digital video cameras that performs preliminary analytics.

The second layer (E2) comprises analytics modules which are embedded inside each of the video cameras in the system and are programmed to perform preliminary analytics based on the input and automatically detect the abnormalities in the rail track using computational video analytics, image processing and artificial neural networks. The second layer (E2) further comprises embedded Preliminary Railway Track Analytics f1_{E2} (106), Preliminary Railway Bed Analytics f2_{E2} (107), Preliminary Railway Track Analytics f3_{E2} (108), Preliminary Deep Inspection Analytics f4_{E2} (109) and Preliminary Stationary Video Camera Video Analytics f5_{E2} (110). (The Preliminary Unmanned Aerial Monitoring Vehicle is not shown in Figure). All the modules in second layer (E2) receive output from the first layer (E1) and sense preliminary deficiencies in the rail track (if any) by combining other factors from the rest of the systems that may contribute to an accident. For example, in one scenario a railway track may have a small crack on the rails and the rail bed below the crack is not in good conditions. When both the above factors are considered independently, they may not cause a serious threat to the train passing above it but when both the factors are combined (based on the output from Preliminary Rail track Analysis (101) and Preliminary railways Bed Analysis (102), it may cause a serious railways accident.

The Preliminary Railway Track Analytics f1_{E2} (106) module is an analytics algorithm which is embedded inside the video camera for performing preliminary analytics based on the computed output from first layer (E1) using artificial neural network. This module performs analytics on various railway track features. The Preliminary Railway Track Analytics f1_{E2} (106) module captures any discontinuity in the track and also performs track breakage prediction to monitor any breakage in the railway track from a distance from a running train. The system performs analytics on the track components such as railway track geometry features, railway track structure feature, railway track curvature feature, railway track level feature, railway track obstruction feature, railway track static obstruction feature, railway track dynamic obstruction feature, railway track stationary collision object feature and railway track dynamic collision object feature. The analytical output of this module is used by various other analytical systems described in the invention, using artificial neural networks.

The Preliminary Railway Bed Analytics f2_{E2} (107) module is embedded inside the video camera and performs preliminary analytics on the output received from various modules in the first layer (E1) using artificial neural networks. This module performs analytics on the railway bed and foundation systems and other associated structures such as sleeps, ballast etc that need a closer monitoring and maintenance. The analytics module in this system perform various analytics such as railway bed geometry features analytics, railway bed rails foundation feature analytics, railway bed formation feature analytics, railway bed ballast feature analytics, railway bed formation feature analytics, railway bed geometrics feature analytics, railway bed shoulder feature analytics and railway bed track foundation feature analytics. The analytical output of this module is used by various other analytical systems described in the invention, using artificial neural networks.

The Preliminary Rail Adjacent Structure Analytics f3_{E2} (108) is an analytics module which is embedded inside the video camera. This module performs preliminary analytics based on the output received from various modules in the first layer (E1) using artificial neural networks. The analytical output of this module is used by various other analytical systems described in the invention. The analytics modules in this module perform various analytics such as railway bridges geometrics feature analytics, railway tunnel geometrics feature analytics, railway high mountain geometrics feature analytics, railway adjacent stationary object feature analytics, railway adjacent moving object feature analytics, adjacent train relative velocity feature analytics, adjacent train relative acceleration feature analytics, adjacent track geometrics feature analytics, railway adjacent environment feature analytics, railway adjacent geographic feature analytics, railway adjacent structure feature analytics and railway climatic features analytics.

The Preliminary Deep Inspection Analytics f4_{E2} (109) is an analytics module which is embedded inside the video camera and performs preliminary analytics based on the input received from various modules in the first layer (E1) using artificial neural networks. This module performs analytics with deeper details to investigate more minute level of measures and defects on the railway track and other components that may cause an accident or need maintenance. The module performs Deep Inspection Analytics on railway earthwork movements, cracks and defective sleepers, cracks and defective railway track, railway drainage systems, railway cracks and defective switching levers, cracks and defective railway bridge holdings, cracks and defects in railway bridges, cracks and defective railway tunnels, track corrosion, cracks and defective welding systems, soil movements and water detection etc. The analytical output of this module is used by various other analytical systems described in the invention.

The Preliminary Stationary Video Camera Video Analytics f5_{E2} (110) is an analytics module which is embedded inside the video camera and performs preliminary analytics based on the input received from various modules in the first layer (E1) using artificial neural networks. (The Preliminary Unmanned Aerial Monitoring Vehicle is not shown in Figure)

All the analytics modules in second layer (E2) receive output from all the modules in the layer (E1) and compute the output (a1_{E1}, a2_{E1}, a3_{E1}, a4_{E1}, and a5_{E1}) by assigning weight to each of such output using artificial neural network.

In one embodiment, the output vector at second layer (E2) may be computed using the following formula:

a1_{E2}=f1_{E2}(P1_{E2}×[W1_{E2}*Z1_{E2}]+B1_{E2})

a2_{E2}=f2_{E2}(P2_{E2}×[W2_{E2}*Z2_{E2}]+B1_{E2})

a3_{E2}=f3_{E2}(P3_{E2}×[W3_{E2}*Z3_{E2}]+B1_{E2})

a4_{E2}=f4_{E2}(P4_{E2}×[W4_{E2}*Z4_{E2}]+B1_{E2})

a5_{E2}=f5_{E2}(P5_{E2}×[W5_{E2}*Z5_{E2}]+B1_{E2})

where
Output Vector (ai_{E2}):

a1_{E2} is the output vector for system f1_{E2}

a2_{E2} is the output vector for system f2_{E2}

a3_{E2} is the output vector for system f3_{E2}

a4_{E2} is the output vector for system f4_{E2}

a5_{E2} is the output vector for system f5_{E2},

wherein Input Vector (Pi_{E2}):

P1_{E2} is the input vector for system f1_{E2}

P2_{E2} is the input vector for system f2_{E2}

P3_{E2} is the input vector for system f3_{E2}

P4_{E2} is the input vector for system f4_{E2}

P5_{E2} is the input vector for system f5_{E2},

where input vector contains the values assigned to the output received from various modules by the second layer (E2)

### Weight Matrix (Wi_{E2})

W1_{E2P1} is the weight scalar for the system f1_{E2} with respect to P1_{E2}

W2_{E2P1} is the weight scalar for the system f2_{E2} with respect to P2_{E2}

W3_{E2P1} is the weight scalar for the system f3_{E2} with respect to P3_{E2}

W4_{E2P1} is the weight scalar for the system f4_{E2} with respect to P4_{E2}

W5_{E2P1} is the weight scalar for the system f5_{E2} with respect to P5_{E2}

The weight matrix is as below:

$$[ W {1}_{E 2} ] = {\sum }_{i = 1}^{5} W 1 E 2 pi \\ ( \begin{matrix}W {1}_{E 2 P 1} & W {1}_{E 2 P 2} & W {1}_{E 2 P 3} & W {1}_{E 2 P 4} & W {1}_{E 2 P 5} \\ W {2}_{E 2 P 1} & W {3}_{E 2 P 2} & W {3}_{E 2 P 3} & W {3}_{E 2 P 4} & {W3}_{E 2 P 5} \\ W {3}_{E 2 P 1} & W {3}_{E 2 P 2} & W {3}_{E 2 P 3} & W {3}_{E 2 P 4} & W {3}_{E 2 P 5} \\ W {4}_{E 2 P 1} & W {4}_{E 2 P 2} & W {4}_{E 2 P 3} & W {4}_{E 2 P 4} & W {4}_{E 2 P 5} \\ W {5}_{E 2 P 1} & W {5}_{E 2 P 2} & W {5}_{E 2 P 3} & W {5}_{E 2 P 4} & W {5}_{E 2 P 5}\end{matrix} )$$

where weight matrix is the value of the weight assigned to each output from the first layer (E1).

### Error Adjustment Factor for Back Propagation (Zi_{E1}):

The matrix for error adjustment factor is as below:

$$( \begin{matrix}Z {1}_{E 2 p 1} & Z {1}_{E 2 p 2} & Z {1}_{E 2 p 3} & Z {1}_{E 2 p 4} & Z {1}_{E 2 p 5} \\ Z {2}_{E 2 p 1} & Z {3}_{E 2 p 2} & Z {3}_{E 2 p 3} & Z {3}_{E 2 p 4} & Z {3}_{E 2 p 5} \\ Z {3}_{E 2 p 1} & Z {3}_{E 2 p 2} & Z {3}_{E 2 p 3} & Z {3}_{E 2 p 4} & Z {3}_{E 2 p 5} \\ Z {4}_{E 2 p 1} & Z {4}_{E 2 p 2} & Z {4}_{E 2 p 3} & Z {4}_{E 2 p 4} & Z {4}_{E 2 p 5} \\ Z {5}_{E 2 p 1} & Z {5}_{E 2 p 2} & Z {5}_{E 2 p 3} & Z {5}_{E 2 p 4} & Z {5}_{E 2 p 5}\end{matrix} )$$

where the Error Adjustment Factor uses the data to adjust the network's weights and thresholds so as to minimize the error in its predictions on the training set. If the network is properly trained, it has then learned to model the (unknown) function that relates the input variables to the output variables, and can subsequently be used to make predictions where the output is not known.

### Bias Vector (Bi_{E2})

B1_{E2} is the Bias for system f1_{E2}

B2_{E2} is the Bias for system f2_{E2}

B3_{E2} is the Bias for system f3_{E2}

B4_{E2} is the Bias for system f4_{E2}

B5_{E2} is the Bias for system f5_{E2}

where bias is the average error that a particular model training procedure makes across different particular data sets (drawn from the unknown function's distribution). The variance reflects the sensitivity of the modeling procedure to a particular choice of data set.

The net stimulus function at second layer (E2) is

$$\begin{matrix}n {1}_{E 2} = ( {\sum }_{i = 1}^{5} W {1}_{E 2 pi} {Pi}_{E 2} * [ Z {1}_{E 2} ] + B {1}_{E 2} ) \\ n {2}_{E 2} = ( {\sum }_{i = 1}^{5} W {2}_{E 2 pi} {Pi}_{E 2} * [ Z {2}_{E 2} ] + B {2}_{E 2} ) \\ n {3}_{E 2} = ( {\sum }_{i = 1}^{5} W {3}_{E 2 pi} {Pi}_{E 2} * [ Z {3}_{E 2} ] + B {3}_{E 2} ) \\ n {4}_{E 2} = ( {\sum }_{i = 1}^{5} W {4}_{E 2 pi} {Pi}_{E 2} * [ Z {4}_{E 2} ] + B {4}_{E 2} ) \\ n {5}_{E 2} = ( {\sum }_{i = 1}^{5} W {5}_{E 2 pi} {Pi}_{E 2} * [ Z {5}_{E 2} ] + B {5}_{E 2} )\end{matrix}$$

The output vector (a1_{E2}, a2_{E2}, a3_{E2}, a4_{E2}, a5_{E2}) from second layer (E2) is passed as input vector (p1_{E3}, p2_{E3}, p3_{E3}, p4_{E3}, p5_{E3}) to the third layer (E3) which performs Preliminary Operational Safety Analytics (111) based on the input received.

The third layer (E3) computes the output by comparing the outputs from layer (E2) with a threshold value and in case it exceeds the threshold value, a preliminary disaster alert is transmitted to preliminary disaster alert (601, FIG. 1) to higher level components in such a case. The third layer (E3) comprises Preliminary Operational Safety Analytics f_{E3} (111) module which is embedded inside the Digital Video Camera System (100) and evaluates and analyzes the operational safety of the train based on the various railway track conditions using analytics outputs from the second layer (E2) using artificial neural networks. The Preliminary Operational Safety Analytics (111) provides key triggers to Preliminary Automatic Emergency Control Systems (112) of the train in case it detects any abnormality from the analytics performed by the modules such as Preliminary Track Feature Analytics (106), Preliminary Railway Bed Analytics (107), Preliminary Adjacent Structure Features Analytics (108), Preliminary Deep Inspection Analytics (109) or Preliminary Stationary Camera Video Analytics (110) on the second layer (E2) that performs preliminary analytics by evaluating various engineering, technical, operational measures against the standard specifications and acceptable limits.

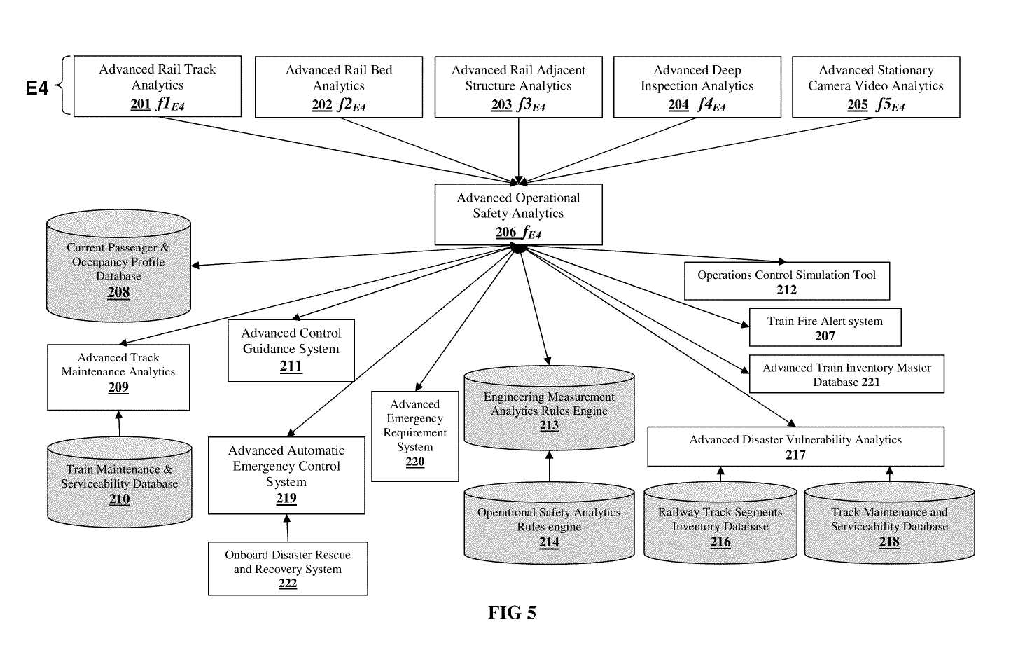

One of the main advantages of the Digital Video Camera System (100) is that this module senses preliminary defects in the rail track (if any) and automatically computes degree of disaster vulnerability from collective analysis of output from the video cameras. In case in case degree of disaster vulnerability exceeds predetermined threshold value, said system triggers (in near real time) to the Preliminary Automatic Emergency Control System (112) as it senses a serious danger such as a broken rail segment, an obstacle on the tracks or any other factor which may cause serious train accident which otherwise may take considerably long time using conventional system. The Preliminary Automatic Emergency Control System (112) in the train may initiate immediate action based on the trigger to avoid the accident or in case of potential danger; the Preliminary Automatic Emergency Control System (112) may also activate various Onboard Rescue and Response System (222) FIG. 5 in order to reduce the impact of the accident on the occupants. The system also transmits potential disaster scenarios with associated impacts immediately to other respective network connected trains that are about to come from opposite direction from a different rail track or to the train that is about to pass through same rail track in future whereby avoiding further damage by trains passing through disaster prone railway track segment location. Hence, the Digital Video Camera System (100) provides an instant train accident avoidance system. The preliminary analytics also includes Preliminary Emergency Maintenance Analytics (113) that detects any abnormalities in the rail track for rectification by the maintenance team. Since, Digital Video Camera System (100) doesn't have other important data available with it such as data about previous trains, and various factors that may cause a train disaster hence the preliminary alert triggered as a result of analytics by Digital Video Camera System (100) is sent for further analysis to the Train Onboard Computer System (200) that aggregates various other important factors that may affect the disaster vulnerability of the train. The Digital Video Camera System (100) avoids damage to train and occupants and considerably reduces the rescue response time by immediately activating rescue and response system and also transmitting disaster alerts for further confirmation from advanced systems in the network.

In one embodiment, the output vector at third layer (E3) may be computed using the following formula:

$${a}_{E 3} = {f}_{E 3} = ( {\sum }_{i = 1}^{5} W {1}_{E 3 pi} {Pi}_{E 3} * {Zi}_{E 3} + {Bi}_{E 3} )$$

$$Net stimulus for system {f}_{E 3} = {n}_{E 3} = ( {\sum }_{i = 1}^{5} W {1}_{E 3 pi} {Pi}_{E 3} * {Zi}_{E 3} + {Bi}_{E 3} )$$

where

### Input Vector (Pi_{E3})

P1_{E3} is the input vector for system f1_{E3}

P2_{E3} is the input vector for system f2_{E3}

P3_{E3} is the input vector for system f3_{E3}

P4_{E3} is the input vector for system f4_{E3}

P5_{E3} is the input vector for system f5_{E3},

### Weight Scalar (Wi_{E3})

W1_{E3} is the weight scalar for system f1_{E3}

W2_{E3} is the weight scalar for system f2_{E3}

W3_{E3} is the weight scalar for system f3_{E3}

W4_{E3} is the weight scalar for system f4_{E3}

W5_{E3} is the weight scalar for system f5_{E3}

where weight scalar is the value of the weight assigned to each input from the video captured by the video cameras in second layer (E2) depending upon the depth of the defect detected by the input vector.

Bias Vector (Bi_{E3})

B1_{E3} is the Bias for System f1_{E3}

B2_{E3} is the Bias for System f2_{E3}

B3_{E3} is the Bias for System f3_{E3}

B4_{E3} is the Bias for System f4_{E3}

B5_{E3} is the Bias for System f5_{E3}

where bias is the average error that a particular model training procedure makes across different particular data sets (drawn from the unknown function's distribution). The variance reflects the sensitivity of the modeling procedure to a particular choice of data set.

### Error Adjustment Factor for Back Propagation

Z1_{E3} is the Error Adjustment Factor for W1_{E3}

Z2_{E3} is the Error Adjustment Factor for W2_{E3}

Z3_{E3} is the Error Adjustment Factor for W3_{E3}

Z4_{E3} is the Error Adjustment Factor for W4_{E3}

Z5_{E3} is the Error Adjustment Factor for W5_{E3}

where the Error Adjustment Factor uses the data to adjust the network's weights and thresholds so as to minimize the error in its predictions on the training set. If the network is properly trained, it has then learned to model the (unknown) function that relates the input variables to the output variables, and can subsequently be used to make predictions where the output is not known.

The neural network computation at third layer (E3) may be computed using the formula below:

$$a = {f}_{E 3} \{ {\sum }_{i = 1}^{5} {W}_{i , E 3} {Z}_{i , E 3} {\sum }_{i = 1}^{5} {f}_{E 2} \{ {\sum }_{i = 1}^{5} [ {W}_{i , E 2} ] {P}_{i , E 2} {Z}_{i , E 2} {\sum }_{i = 1}^{5} {f}_{E 1} \{ {\sum }_{i = 1}^{5} [ {W}_{i , E 1} ] {P}_{i , E 1} {Z}_{i , E 1} + {B}_{i , E 3} + \} {B}_{i , E 2} + \} {B}_{i , E 3} \}$$

The Preliminary Disaster Vulnerability Analytics (115) module evaluates disaster vulnerability potential of the train based on the input received from various video analytics such as input received from Preliminary Rail Track Analytics (106), Preliminary Railway Bed Analytics (107), Preliminary Adjacent Structure Features Analytics (108), Preliminary Deep Inspection Analytics (109) or Preliminary Stationary Camera Video Analytics (110). The Preliminary Disaster Vulnerability Analytics (115) module is a key component in the system that provides the preliminary triggers to Preliminary Automatic Emergency Control System (111) and Preliminary Control Guidance System (114) whenever some deviation or abnormality in the calculations is observed. The system automatically calculate the degree of disaster vulnerability and in case the degree of disaster exceeds a predetermined threshold value, the system immediately sends a trigger (in micro seconds) to the Preliminary Automatic Emergency Control System (111) as it senses a serious danger such as a broken rail segment, an obstacle on the tracks or any other factor which may cause serious train accident which otherwise may take few minutes using conventional GPS system.

The Preliminary Automatic Emergency Control System (112) is a system which is essentially responsible for triggering Onboard Disaster Rescue and Recovery System (902) FIG. 1 based upon the output received from the Preliminary Operational Safety Analytics (111) which evaluates operational safety and disaster vulnerability of the passengers inside the train. Based on the trigger received from Preliminary Disaster Vulnerability Analytics (115), the Preliminary Automatic Emergency Control System (112) in the train may take immediate action based on the trigger to avoid the accident or in case of potential danger; The Preliminary Automatic Emergency Control System (112) may also activate various Onboard Disaster Rescue and Recovery System (902) in order to reduce the impact of the accident on the occupants.

The Preliminary Emergency Maintenance Analytics (113) module evaluates various immediate maintenance, repair, deep inspection and investigation video stream to assess various emergency maintenance requirements in the tracks and train systems which are related to safety of the train and railway track. Alert for maintenance is triggered based upon the intensity of the irregularity detected.

The Preliminary Control Guidance System (114) computes and provides operations command control guidance to the train operating personnel, engine driver, train controller, onboard maintenance engineer and emergency staff related to the running train operations and controls such as speed, break accelerations etc using the inputs received from embedded analytics modules.

Hence, the Digital Video Camera System (100) provides an instant train accident avoidance system. Since, Digital Video Camera System (100) doesn't have other important data available with it such as data about previous trains, and various factors that may cause a train disaster hence, in case the degree of disaster vulnerability is below the predetermined threshold value, output from preliminary analytics is sent for further analysis to the Train Onboard Computer System (200) that performs advanced analytics by combining various other important factors that may affect the disaster vulnerability of the train.

### EXAMPLES

In one scenario, a railway track may have abnormalities in the railway gauge measurement or the railway track may have a twist. At the same time, the train is running at a speed of 150 km per hour on the railway track where soil erosion has taken place due to heavy rains which shall have impact on the railway bed. In such a situation all the outputs when considered individually may be below the threshold level of the disaster vulnerability for a train to run but when all the factors are combined for a collective analysis, it may cause a serious train disaster.

In another scenario, the railway track gauge measurement is out of range of the operational safety and the train is passing at a speed of 160 miles per hour through a track segment which is a bridge over a 300 m deep river or is passing through a mountain range with a 3000 m valley adjacent to the railway track. The disaster assessment of the train is computed by taking into consideration all the above factors collectively to prevent a potential accident. Based on the disaster vulnerability of the train, proper rescue and response systems are applied and a disaster vulnerability alert is generated accordingly.

In another situation the train railway track measurement is out of range of the operational safety and the track segment is a 30 m high over bridge in an urban location near a huge market or busy road below the over bridge. When the train is running at a speed of 120 miles per hour through the over bridge, the disaster vulnerability of the train increases manifold when compared to a train passing through a normal railway track on plain area due to the disaster impact for the occupants inside the train as well as the persons adjacent to the railway track.

In another situation the train is passing through a mountain range and a huge crater is moving towards the train at a speed of 160 Km per hour. In such a situation the disaster vulnerability of the train becomes very high and time to recover and rescue is very limited due the mountain range.

There may be various factors such as defects in the railway tracks; maintenance quality of the train, speed of the train, wind speed or climatic and geographic conditions of the region the train is passing through that affect the disaster vulnerability of the train to a great extent. The present invention dynamically computes and updates the disaster vulnerability profile as the train passes through various track segments, changes speed, and passes through various geographical areas with different climatic conditions. Based on the disaster vulnerability of the train, proper rescue and response systems are applied and a disaster vulnerability alert is generated accordingly.

Referring now to FIG. 5 that illustrates a block diagram of the Train Onboard Computer System in accordance with one embodiment of the invention. The fourth layer (E4) includes Train Onboard Computer System (200) installed on a compartment inside the train and comprises high speed computing devices in network communication with Digital Video Camera System (100) via real time communication network. After performing various preliminary video analytics at the Digital Video Camera System (100), the neural network analytics output, selected video clips and disaster prone video frames are received by the Train Onboard Computer System (200) to perform advanced analytics on the output using artificial neural network, fuzzy logic and expert systems. The advanced analytics performed by the Train Onboard Computer System (200) comprise Advanced Rail Track Analytics (201), Advanced Rail Bed Analytics (202), Advanced Adjacent Structure Analytics (203), Advanced Deep Inspection Analytics (204), Advanced Stationary Camera Video Analytics (207) and Advanced Unmanned Aerial Monitoring Vehicle (not shown in Figure). Train Onboard Computer System (200), additionally may retrieve and use comprehensive and wide range of information such as the current occupancy passenger profile database, complete railway route information which is not just limited to video images of the route, railway segment profile (bridges, tunnels, mountain ranges), railway segment maintenance engineering and reliability and train maintenance engineering and reliability information. The Train Onboard Computer System (200) performs advanced analytics on the output from Digital Video Camera System (100) and detects the abnormalities (if any) in the railway track, railway bed and railway adjacent structure even in case the Digital Video Camera System (100) is unable to detect the same as the Train On board Computer System (200) performs much detailed advanced analytics by combining various other factors that may contribute to the train disaster.

The Advanced Rail Track Analytics f1_{E4} (201) module is embedded in computing devices in the Train Onboard Computer System (200) and uses various previous video analytics database information for identifying patterns and calibrates the measurement specifications bases on advanced learning algorithms using expert systems and artificial intelligence and fuzzy logics. Upon receiving output from the third layer (E3), the computing devices in the Train Onboard Computer System (200) perform Advanced Rail Track Analytics f1_{E4} (201) that analyze the railway track system and associated structure once more to ensure any discrepancy in the output received from Digital Video Camera System (100). This module evaluates various engineering, technical, operational measures against the standard specifications and acceptable limits. The analytical output of this module is used by various other onboard analytical systems described in the invention, using artificial neural network.

The Advanced Rail Bed Analytics f2_{E4} (202) module is embedded inside the computing devices in the Train Onboard Computer System (200) and performs advanced analytics upon receiving output from the third layer (E3). This module analyzes the railway bed and foundations systems and associated structures such as sleeps, ballast etc. This module uses various previous video analytics database information for identifying patterns and calibrates the measurement specifications based on advanced learning algorithms using expert systems and artificial intelligence and fuzzy logics. This module takes feature analysis output from the railway track feature analysis module from embedded analytics layer and also evaluates various engineering, technical, operational measures against the standard specifications and acceptable limits. The analytical output of this module is used by various other onboard analytical systems described in the invention using artificial neural network.

The Advanced Adjacent Structure Analytics f_{E4} (203) module in the Train Onboard Computer System (200) performs advanced analytics upon receiving output from the third layer (E3). The module analyzes the railway adjacent structure and associated structures such as adjacent track lines, signal posts, building walls, bridge walls, tunnel walls etc. This module is embedded in the Train Onboard Computer System (200) and uses various pervious video analytics database information for identifying patterns and calibrates the measurement specifications based on advanced learning algorithms using expert systems and artificial intelligence and fuzzy logics. This module takes feature analysis output from the railway track feature analysis module from embedded analytics layer. This module evaluates various engineering, technical, operational measures against the standard specifications and acceptable limits. The analytical output of this module is used by various other onboard analytical systems described in the invention using artificial neural network.

The Advanced Deep Inspection Analytics f4_{E4} (204) module in the Train Onboard Computer System (200) performs advanced analytics upon receiving output from the third layer (E3). This module analyzes the railway track, railway bed and adjacent structure with deeper inspection to investigate more minute level of measures and defects which remained undetected by the preliminary analytics by Digital Video camera System (100). This module is embedded in the Train Onboard Computer System (200) and uses various pervious video analytics database information for identifying patterns and calibrates the measurement specifications based on advanced learning algorithms using expert systems and artificial intelligence and fuzzy logics. This module evaluates various engineering, technical, operational measures against the standard specifications and acceptable limits. The analytical output of this module is used by various other analytical systems described in the invention. This module performs advanced analytics on railway earthwork movements, cracks and defective sleepers, cracks and defective railway track railway drainage systems, railway cracks and defective switching levers, cracks and defective railway bridge holdings, cracks and defects in railway bridges, cracks and defective railway tunnels, track corrosion, cracks and defective welding systems, soil movements and water detection etc.

The Advanced Stationary Video Camera Video Analytics f5_{E4} (205) receives output from various preliminary modules and performs advanced analytics on the output received using artificial neural network. This module is embedded in the Train Onboard Computer System (200) and uses various pervious video analytics database information for identifying patterns and calibrates the measurement specifications based on advanced learning algorithms using expert systems and artificial intelligence and fuzzy logics. (The Advanced Unmanned Aerial Monitoring Vehicle is not shown in Figure)

The Advanced Operational Safety Analytics f_{E4} (206) is an embedded module and has access to various information and rules related to operational safety specification and reliability specifications which are specifically related to individual train system with respect to relevant railway track segments in the given rail route. The analytic rules engine used in this system is a data mining rules engine that automatically learns various patterns of the operational statistics and calibrates the analytics rules constructs. The Train Onboard Computer System (200) is synchronized in real time with the Central Command Control Center (300) on frequent intervals using communication network. This module receives output from Advanced Rail Track Analytics f1_{E4} (201), Advanced Rail Bed Analytics f2_{E4} (202), Advanced Adjacent Structure Analytics f3_{E4} (203), Advanced Deep Inspection Analytics f4_{E4} (204) and Advanced Stationary Video Camera Video Analytics f5_{E4} (205) inside the Train Onboard Computer System (200). Since the Digital Video Camera System (100) has a limited amount of data available as it merely records the video images of the track and performs preliminary analytics on the captured video images without taking into consideration the other key factors related to train condition, passenger profile and other related factors that may affect the disaster vulnerability of the train.

The computing devices in the Train Onboard Computer System (200) are configured to store databases of the information such as real time profile of each passenger stored in Current Passenger and Occupancy Profile Database (208), Railway Track Segments Inventory Database (216) storing data related to segment profiles of various tracks segments, Engineering Measurement Analytics Rule Engine (213) data related to engineering safety specifications, all the maintenance aspect of the train compartment and associated systems stored in Train Maintenance and Serviceability Database (218), all the maintenance and serviceability records related to railway track and associated systems stored in Track Maintenance and Serviceability Master (210), various records of track segment profiles of various tracks segments such as track position in relation with GPS, geographical characteristics, operational characteristics, structural characteristics, environmental characteristics on a given rail route which are stored in Railway Track Segments Inventory Database (216). The Train Onboard Computer System (200) receives output from the preliminary analytics performed by the embedded analytics module in the Digital Video Camera System (100) and performs comprehensive and deeper level of advanced analytics by using real-time train data contributing to a potential disaster. The real-time train data maintained by Train Onboard Computer System (200) comprises train speed, vibration in the train, number of compartments in the train, maintenance status of the train, railway segment profile, data from previous train runs and historical information from the stored database for considering train related factors contributing to an accident or disaster in addition to track related abnormalities.

Based on the collective analysis of the above factors a train disaster vulnerability profile is created and based on the vulnerability of the passengers, a passenger disaster vulnerability profile is created. The Advanced Operational Safety Analytics f_{E4} (206) reexamines the output from third layer (E3) by combining the real-time train data from the above databases and computes a real time train vulnerability profile for each train based on the real time train data which is constantly updated depending upon variations in these parameters. The system automatically computes the degree of disaster vulnerability based on the collective analysis of train disaster vulnerability profile and passenger disaster vulnerability profile and triggers an advanced disaster alert. In case the degree of disaster vulnerability exceeds a predetermined threshold value, Advanced Automatic Emergency Control System (219) immediately takes necessary precautionary measures to avoid the potential accident or disaster. The Advanced Automatic Emergency Control System (219) may also activate various Onboard Disaster Rescue and Recovery System (222) in order to reduce the impact of the accident on the occupants. The advanced analytics transmit Advanced Emergency Maintenance Requirement System (220) of the railway track in case it detects any abnormalities in the Rail Track after advanced analytics for rectification of the abnormality. In case the degree of disaster vulnerability is below the predetermined threshold value, output from advanced analytics is sent for further analysis to the Central Command Control Computation System (300) that aggregates various other geographical factors that may affect the disaster vulnerability of the train. Further Train Onboard Computer System (200) also provides self-learning capabilities and back propagation feedback to Train Onboard Computer System (200) Components.

The output vector (a1_{E3}, a2_{E3}, a3_{E3}, a4_{E3}, a5_{E3}) from the modules f1_{E3}, f2_{E3}, f3_{E3}, f4_{E3} and f5_{E3} respectively on the third layer (E3), is passed as input vector (p1_{E4}, p2_{E4}, p3_{E4}, p4_{E4}, p5_{E4}) to the fourth layer (E4) to perform advanced analytics.

In one embodiment, the output at fourth layer (E4) may be computed using the following formula:

$$Output vector for system = {a}_{E 4} = ( {\sum }_{i = 1}^{5} {Wi}_{E 4} * {Pi}_{E 4} * {Zi}_{E 4} + {Bi}_{E 4} )$$

$$Net stimulus for system {f}_{E 4 } = {n}_{E 4} = ( {\sum }_{i = 1}^{5} {Wi}_{E 4} * {Pi}_{E 4} + {Bi}_{E 4} )$$

where:

### Input Vector (Pi_{E4})

P1_{E4} is the input vector for system f1_{E4}

P2_{E4} is the input vector for system f2_{E4}

P3_{E4} is the input vector for system f3_{E4}

P4_{E4} is the input vector for system f4_{E4}

P5_{E4} is the input vector for system f5_{E4}

where input vector contains the values assigned to the video captured by the video cameras in first layer (E4)

### Weight Scalar (Wi_{E4}):

W1_{E4} is the weight scalar for system f1_{E4}

W2_{E4} is the weight scalar for system f2_{E4}

W3_{E4} is the weight scalar for system f3_{E4}

W4_{E4} is the weight scalar for system f4_{E4}

W5_{E4} is the weight scalar for system f5_{E4}

where weight scalar is the weight assigned to the each input from the third layer (E3) depending upon the depth of the defect detected by the input vector.

### Bias Vector (Bi_{E4})

B1_{E4} is the bias vector for system f1_{E4}

B2_{E4} is the bias vector for system f2_{E4}

B3_{E4} is the bias vector for system f3_{E4}

B4_{E4} is the bias vector for system f4_{E4}

B5_{E4} is the bias vector for system f5_{E4}

### Error Adjustment Factor for Back Propagation (Zi_{E1):}

Z1_{E4} is the Error Adjustment Factor for W1_{E4}

Z2_{E4} is the Error Adjustment Factor for W2_{E4}

Z3_{E4} is the Error Adjustment Factor for W3_{E4}

Z4_{E4} is the Error Adjustment Factor for W4_{E4}

Z5_{E4} is the Error Adjustment Factor for W5_{E4}

where the Error Adjustment Factor uses the data to adjust the network's weights and thresholds so as to minimize the error in its predictions on the training set. If the network is properly trained, it has then learned to model the (unknown) function that relates the input variables to the output variables, and can subsequently be used to make predictions where the output is not known.

The Current Passenger and Occupancy Profile Database (208) automatically computes a real-time profile for each passenger inside the train based on the parameters such as seat number of the passenger, medical condition of the passenger, physical condition of the passenger, age and sex of the passenger, total number of compartments in the train, train compartment number where the passenger is located, speed of the train, type of the disaster and the impact magnitude of the disaster. The Current Passenger and Occupancy Database (208) is limited only to a specific train run for a particular date and is limited only to the passengers inside said train at a particular day. The Current Passenger and Occupancy Profile Database (208) for each passenger is constantly updated based on the number of passenger boarding the train or passengers getting down from the train at different stations. The data saved in Current Passenger and Occupancy Profile Database (208) is used at the time of rescue operation in case of an emergency such as collision or fire etc. The system applies an appropriate Onboard Disaster Rescue and Recovery System (222) based on the Current Passenger and Occupancy Profile Database (208) of the passengers inside the train and reduces the damage caused by taking timely and suitable measures.

The Track Maintenance and Serviceability Master (210) provides all the maintenance and services ability records related to railway track and associated systems to Advanced Track Maintenance Analytics (209). The records include reliability information and repair information of various track segment in the given rail route which train undertakes.

The Advanced Control Guidance System (211) computes and provides operations command control guidance to the train operating personnel, engine driver, train controller, onboard maintenance engineer and emergency staff related to the various train operations and controls such as speed, breaks, accelerations etc using the inputs received from various embedded Digital Video Camera System (100) and Train Onboard Computer System (200).

The Operations Control Simulation Tool (212) computes various command control analysis using “What If” simulation of various control alternatives using onboard video analytics information and central historical information under various operational, environmental and structural conditions, vulnerabilities and variability. This system is synchronized with the central rail network operational profile in real time basis using Communication Network.

The Engineering Measurement Analytics Rule Engine (213) in the Train On Board Computer system (200) is a data mining rules engine that automatically learns and updates the specifications and the patterns of the engineering and reliability statistics and calibrates the analytics rules constructs. This component takes inputs from the video analytics components from the Digital Video Camera System (100). The analytic rules in this engine are synchronized in real time with the systems in Central Command Control Computation System (300) on frequent intervals using communication network. This rules engine is an embedded component and provides information and rules construct related to railway track and engineering safety specification, railway track technical safety specification and track reliability specifications which are related to individual track system railway track segments in a given rail route. This component is used by Advanced Control Guidance System (211) and Advanced Disaster Vulnerability Analytics (217) for computing the fourth layer (E4) advanced analytics. The Engineering Measurement Analytics Rule Engine (213) records all the track related information for each rail segment while passing through and stores such information. The data stored in this module is further used by the Central Operational Safety Analytics (306) in the Central Command Control Computation Centre (300).

The Advanced Operational Safety Analytics Rule Engine (214) evaluates various operational safety components using possible scenarios, based on the input received from various embedded and onboard video analytics information and central command systems through communication network in real time. This component is also a key component in providing key triggers to Advanced Automatic Emergency Control System (219) and Advanced Control Guidance System (211).

The Advanced Disaster Vulnerability Analytics (217) module evaluates disaster vulnerability potential of the train and performs various disaster vulnerability computations using possible disaster scenarios, based on the input received from various embedded Digital Video Camera System (100) and Train Onboard Computer System (200) using the operational safety analytics and maintenance analytics systems. The Advanced Disaster Vulnerability Analytics (217) module is a key component in the system that provides the advanced triggers to Advanced Automatic Emergency Control System (219) and Advanced Control Guidance System (211) whenever some abnormality or discrepancy in the calculations is observed. Additionally Advanced Disaster Vulnerability Analytics (217) compute the disaster vulnerability from pre-stored disaster modeling information using pre-stored obstruction object images, pre-stored obstruction patterns and associated disaster vulnerabilities in order to quickly identify and assess the disaster vulnerability levels.

The Railway Track Segments Inventory Database (216) stores various records of segment profiles of various tracks segments such as track position in relation with GPS, geographical characteristics, operational characteristics, structural characteristics, environmental characteristics on a given rail route. This data base is synchronized with the Central Command Control Computation System (300) in near real time basis using communication network. The Railway Track Segments Inventory Database (216) is used to tag the captured videos with the location tags with time stamps in order to carry out non real time analysis of various video analytics.

The Train Maintenance and Serviceability Database (218) maintains all the maintenance aspect of the train compartment and associated systems including engine with details of up to date maintenance records related to mechanical, electronic and computer systems compartments and sub systems and its details and information of a particular train. This system maintenance information system also maintains the serviceability status and maintenance log information associated with the individual component and sub components.

The Advanced Automatic Emergency Control System (219) is a system which is essentially responsible for triggering Onboard Disaster Rescue and Recovery System (222) based upon the output received from the Advanced Operational Safety Analytics (206) which evaluates operational safety and disaster vulnerability of the passengers inside the train.

The Advanced Emergency requirement System (220) module evaluates various video analytics output information and deep inspection and investigation video stream to assess various emergency maintenance requirements in the tracks and train systems which are related to safety of the train and railway track.

The Advanced Train Inventory Master (221) maintains and provides information about all the systems and sub systems inside a train to the Advanced Disaster Vulnerability Analytics (215). The information maintained by the module includes details about the mechanical system, electronic system and computer systems, compartments and sub systems. This module also provides information of a particular train at any given point of time. This system inventory system also maintains the serviceability status and maintenance log information associated with the individual component and sub component.

### EXAMPLES

a) Disaster Vulnerability Analytics based on various climatic, environmental and geographic conditions and the video images of a particular railway route from the previous and immediate trains passed which is communicated through wide area communication module.

b) Disaster Vulnerability Analytics based on maintenance conditions of the railway segment in the particular railway route from the previous and immediate trains passed which is communicated through wide area communication module.

c) Disaster Vulnerability Analytics based on passenger of the railway segment in the particular railway route from the previous and immediate trains passed which is communicated through wide area communication module.

d) Disaster Vulnerability Analytics based on Disaster Vulnerability Assessment of a particular railway route from the previous and immediate trains passed which is communicated through wide area communication module.

e) In case of a fire in any particular compartment estimating the disaster vulnerability assessment of the train, compartment and passengers.

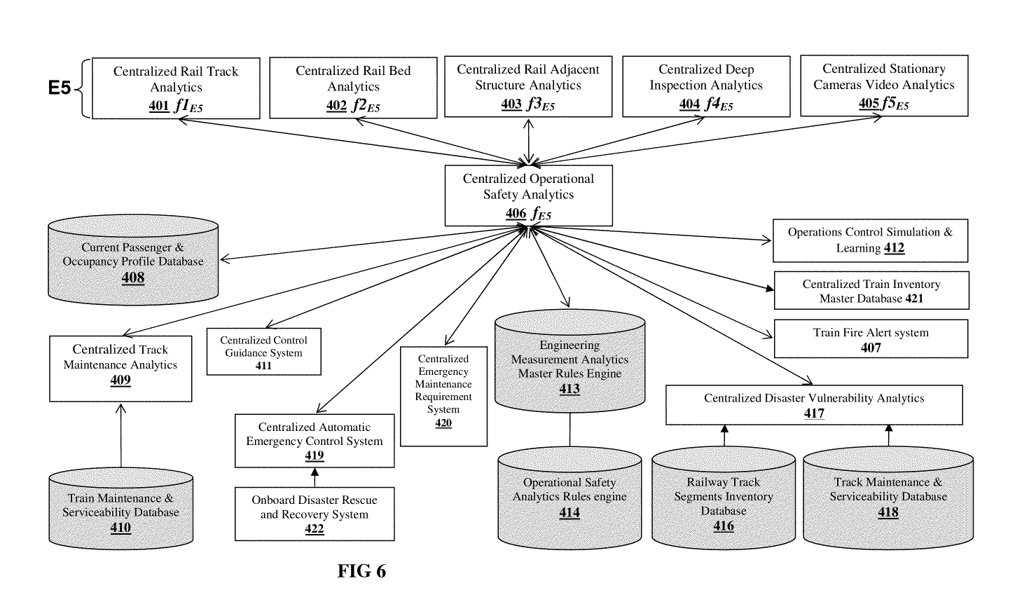

Referring now to FIG. 6 that illustrates a block diagram of the Central Command Control Computation System in accordance with one embodiment of the invention. The Central Command Control Computation System (300) is a centralized information system in a geographical area which is configured to communicate with Digital Video Camera System (100) and the Digital Train Onboard Computer System (200) mounted on each train via communication network. The Central Command Control Computation System (300) has plurality of network connected high speed computing devices and is connected to the Train Onboard Computer System (200) via communication network for transmitting and receiving data in real time. The computing devices at Central Command Control Computation System (300) receive real time data from the Digital Video Camera System (100) and Train Onboard Computer System (200) and perform centralized analytics on the output from them. The Central Command Control Computation System (300) has access to real-time geographical and environmental data of the rail route. The real-time geographical and environmental data comprises real time geographic features of area the train is passing through and real time environmental factors prevailing in a particular rail route whereby combining environmental factors as well as geographical factors to advanced analytics output that may contribute to a potential disaster and subsequently taking necessary precautionary measures to avoid such disaster. The real-time geographical and environmental data may also include information about other trains running on the same route to avoid any potential collision, real time geographic features such as existence of mountain range that increase the train vulnerability, climatic and environmental factors such as rain, storm, wind speed, existence of deep valley or mountain range and also previous records/analytics outputs from the other trains.

The Central Command Control Computation System (300) comprises Centralized Rail Track Analytics f1_{E5} (401), Centralized Rail Bed Analytics f2_{E5} (402), Centralized Rail Adjacent Structure Analytics f3_{E5} (403), Centralized Railway Deep Inspection Analytics f4_{E5} (404), Centralized Stationary Cameras Video Analytics f5_{E5} (407) and Centralized Unmanned Aerial Monitoring Vehicle (not shown in Figure).

The Centralized Rail Track Analytics f1_{E5} (401) is embedded in the Central Command Control Computation System (300) in the Central Command Control Operations Center. The Centralized Rail Track Analytics f1_{E5} (401) performs collective and centralized analytics based on the output received from the fourth layer (E4) from various Trains running across the Railway Network.

Upon receiving output from the fourth layer (E4), the computing devices in the Train Onboard Computer System (200) perform Centralized Rail Track Analytics f1_{E5} (401) that analyze the railway track system and associated structure with more detail to ensure any discrepancy in the output received from Train On Board Computer System (200). The Centralized Rail Track Analytics f1_{E5} (401) performs analytics through statistical models using entire centralized databases by patterns recognition, correlation analysis, advanced learning algorithms using expert systems and artificial intelligence and fuzzy logics based artificial neural network to calibrate the measurement specifications. This module receives track feature analysis output from the Preliminary Railway Track Feature Analytics (101) and Advanced Railway Track Analytics (201) via communication network. The module evaluates various engineering, technical, operational measures against the standard specifications and acceptable limits. The analytical output of the system is used by various other analytical modules described in the invention. The Centralized Rail Track Analytics f1_{E5} (401) additionally performs comprehensive and deeper level of analytics using data mining and knowledge discovery techniques and artificial neural network, fuzzy logic and expert system from previous train runs and historical railway track analytics information from the stored in the database at Central Command Control Operations Center.

The Centralized Rail Bed Analytics f2_{E5} (402) is embedded in the Central Command Control Computation System (300) in the Central Command Control Operations Center and performs centralized analytics based on the input received from the fourth layer (E4). This module analyzes the railway bed and foundation systems and associated structures such as sleeps, ballast etc. The system is embedded in the Central Command Control Computation System (300) in the Central Command Control Operations Center. The module computes the railway bed and foundation structure by statistical models using the entire video analytics database by patterns recognition, correlation analysis, advanced learning algorithms using expert systems and artificial intelligence and fuzzy logics based artificial neural network to calibrate the measurement specifications. The module receives feature analysis output from the Railway Track Feature Analytics (101) and Advanced Railway Track Analytics (201) via communication network. The module evaluates various engineering, technical, operational measures against the standard specifications and acceptable limits. The analytical output of the system is used by various other analytical systems described in the invention. The Centralized Rail Bed Analytics f2_{E5} (402) additionally performs comprehensive and deeper level of analytics using data mining and knowledge discovery techniques and artificial neural network, fuzzy logic and expert system from previous train runs and historical rail bed analytics information from the stored in the database at central command control operations center.

The Centralized Rail Adjacent Structure Analytics f3_{E5} (403) is embedded in the Central Command Control Computation System (300) in the Central Command Control Operations Center and performs centralized analytics based on the input received from the fourth layer (E4) deeper detail. This module analyzes the railway adjacent structure and associated structures such as adjacent track lines, signal posts, building walls, bridge walls, tunnel walls etc. The module is embedded in the Centralized Computer System in Central Command Control Operations Center. This module also computes the railway track analytics through statistical modules using entire video analytics database using patterns recognition, correlation analysis, advanced learning algorithms using expert systems and artificial intelligence and fuzzy logics based artificial neural network to calibrate the measurement specifications. The module receives feature analysis output from the Railway Adjacent Structure Analytics (103) embedded into the Digital Video Camera System (100) and Advanced Railway Adjacent Structure Analytics (203) inside the Train Onboard Computer System (200) via Communication Network. The module evaluates various engineering, technical, operational measures against the standard specifications and acceptable limits. The analytical output of the system is used by various other analytical systems described in the invention. The Centralized Railway Deep Inspection Analytics f3_{E5} (403) additionally performs comprehensive and deeper level of analytics using data mining and knowledge discovery techniques and artificial neural network, fuzzy logic and expert system from previous train runs and historical Rail Adjacent Structure Analytics information from the stored in the database at Central Command Control Operations Center.

The Centralized Railway Deep Inspection Analytics f4_{E5} (404) is embedded in the Central Command Control Computation System (300) in the Central Command Control Operations Center and performs centralized analytics based on the input received from the fourth layer (E4) deeper detail. This module further analyzes preliminary and advanced Rail Track Analytics, Rail Bed Analytics and Rail Adjacent Structure Analytics with deeper inspection to investigate more minute level of measures and defects. This module also computes the Railway Track Analytics using statistical modules using the entire video analytics database using patterns recognition, correlation analysis, advanced learning algorithms using expert systems and artificial intelligence and fuzzy logics based artificial neural network to calibrate the measurement specifications. The module receives feature analysis output from the Preliminary Railway Deep Inspection Analytics (104) embedded into the Digital Video Camera System (100) and Advanced Railway Deep Inspection Analytics (204) inside the Train Onboard Computer System (200) via Communication Network. This module evaluates various engineering, technical, operational measures against the standard specifications and acceptable limits. The analytical output of the system is used by various other analytical systems described in the invention. The Centralized Railway Deep Inspection Analytics f4_{E5} (404) additionally performs comprehensive and deeper level of analytics using data mining and knowledge discovery techniques and artificial neural network, fuzzy logic and expert system from previous train runs and historical Rail Adjacent Structure Analytics (403) information from the stored in the database at Central Command Control Operations Center.

The Centralized Stationary Cameras Video Analytics f5_{E5} (405) receives input from various advanced modules and performs centralized analytics. This module is embedded in the central Command Control Computation System (300) and uses various pervious video analytics database information for identifying patterns and calibrates the measurement specifications based on advanced learning algorithms using expert systems and artificial intelligence and fuzzy logic. The Centralized Stationary Cameras Video Analytics f5_{E5} (405) performs analytics procedure on retrieved information from all the stationary video cameras across the rail network. The Centralized Rail Track Analytics f5_{E5} (405) additionally performs comprehensive and deeper level of analytics using data mining and knowledge discovery techniques and artificial neural network, fuzzy logic and expert system from all the stationary video cameras and historical Stationary Cameras Video Analytics (405) information from the stored database at Central Command Control Operations Center. The system may optionally include high speed digital video camera mounted on unmanned aerial monitoring vehicle for capturing, measuring, computation and performing centralized analytics of railway track features and adjacent structure using computational video analytics, image processing and artificial neural networks.

The Centralized Operational Safety Analytics f_{E5} (406) is an embedded component in the computing systems in Central Command Control Operations Center which provides master operational safety specification, technical safety and reliability specification with associated evaluation rules constructs. The Centralized Operational Safety Analytics f_{E5} (406) additionally performs comprehensive and deeper level of analytics using data mining and knowledge discovery techniques and artificial neural network, fuzzy logic and expert system from previous train runs and historical Operational Safety Analytics information from the stored database at Central Command Control Operations Center. This module receives output from Centralized Rail Track Analytics f1_{E5} (401), Centralized Rail Bed Analytics f2_{E5} (402), Centralized Adjacent Structure Analytics f3_{E5} (403), Centralized Deep Inspection Analytics f4_{E5} (404) and Centralized Stationary Video Camera Video Analytics f5_{E5} (407) in the Central Command Control Computation System (300). The output from this module provides unique derivative of individual train system (via preliminary analytics from Digital Video Camera System (100)) and railway track segments (via advanced analytics from Train Onboard Computer System (200)) of particular rail routes. The output from this module is used by various other Central Control Guidance System (411) and Central Disaster Vulnerability Analytics (417) and Centralized Emergency Maintenance Requirement System (420). The Analytic Rules Engine used in this module is a data mining rules engine which is capable of learning from previous operational records database and calibrate the specifications evaluation rules constructs based on the previous learning. The module communicates with other components which are part of the Train Onboard Computer System (200) and embedded video analytics layer in the Digital Video Camera System (100) using communication network synchronized in real time.

The Centralized Operational Safety Analytics f_{E5} (406) additionally performs comprehensive and deeper level of analytics by using real-time geographic and environmental data contributing to a potential disaster. The real-time geographic and environmental data comprises real time geographic features and real time environmental factors prevailing in the rail route whereby combining environmental factors as well as geographical factors to advanced analytics output that may contribute to a potential disaster and subsequently taking necessary precautionary measures to avoid such disaster. The real-time geographical and environmental data may also include information about other trains running on the same route to avoid any potential collision, real time geographic features such as existence of mountain range that increase the train vulnerability, climatic and environmental factors such as rain, storm, wind speed, existence of deep valley or mountain range and also previous records/analytics outputs from the other trains. The Central Command Control Computation System (300) receives output from the advanced analytics performed by the Train Onboard Computer System (200) and based on the collective output of the above factors, a train disaster vulnerability profile is created and based on the vulnerability of the passengers, a passenger disaster vulnerability profile is created. The Central Command Control Computation System (300) computes a final disaster vulnerability profile of the train by aggregating the output received from Train Onboard Computer System (200) and the output received from Central Command Control Computation System (300) along with real-time geographic and environmental data contributing to a potential disaster. The system computes a real time train vulnerability profile based on the real time train data and real-time geographical and environmental data wherein the train vulnerability profile is constantly updated depending upon variations in the parameters. Based on the vulnerability of the passengers, a passenger disaster vulnerability profile is also created. The system automatically computes the degree of disaster vulnerability based on the collective analysis of centralized analytics, train disaster vulnerability profile and passenger disaster vulnerability profile and triggers a Centralized Disaster Alert (605). In case the degree of disaster vulnerability exceeds a predetermined threshold value, the central command control immediately takes necessary precautionary measures to avoid the potential accident or disaster. The system also transmits potential disaster scenarios with associated impacts are immediately to other respective network connected trains that are about to come from opposite direction from a different rail track or to the train that is about to pass through same rail track in future whereby avoiding further damage by trains passing through disaster prone railway track segment location. Some examples of potential disaster scenario may include a situation where a minor/major earth quake, landslides or floods have damaged a railway track segment. In such a situation, the defective railway track segment is assessed and evaluated for disaster vulnerability to operate the train in those particular segments. The Centralized Automatic Emergency Control System (419) may also activate various Onboard Disaster Rescue and Recovery System (422) in order to reduce the impact of the accident on the occupants. The advanced analytics also transmits information to Centralized Emergency Maintenance Requirement System (420) of the railway track in case degree of disaster vulnerability is below the predetermined threshold after centralized analytics for rectification of the detected abnormality in the rail route for ensuring complete safety of the rail route for future train runs. The Central Command Control Computation System (300) also facilitates inter train communication in a railway network which are mutually related by a common railway track or common rail route segments. The Central Command Control Computation System (300) performs comprehensive and deeper level of analytics using data mining and knowledge discovery techniques along with artificial neural network, fuzzy logic and expert system from previous train runs and historical information from the stored database at Central Command Control Operations Center. Further Central Command Control Computation System (300) also provides self-learning capabilities and back propagation feedback to Train Onboard Computer System (200) components and Digital Video Camera System (100) components.

In one embodiment, the output vector at fifth layer (E5) may be computed using the following formula:

$$Output vector for system = {a}_{E 5} = ( {\sum }_{i = 1}^{5} {Wi}_{E 5} * {Pi}_{E 5} * {Zi}_{E 5} + {Bi}_{E 5} )$$

$$Net stimulus for system {f}_{E 5} = {n}_{E 5} = ( {\sum }_{i = 1}^{5} {Wi}_{E 5} * {Pi}_{E 5} + {Bi}_{E 5} )$$

where:

Input Vector (Pi_{E5})

P1_{E5} is the input vector for system f1_{E5}

P2_{E5} is the input vector for system f2_{E5}

P3_{E5} is the input vector for system f3_{E5}

P4_{E5} is the input vector for system f4_{E5}

P5_{E5} is the input vector for system f5_{E5}

### Weight Matrix (Wi_{E5})

W1_{E5} is the weight scalar for system f1_{E5}

W2_{E5} is the weight scalar for system f2_{E5}

W3_{E5} is the weight scalar for system f3_{E5}

W4_{E5} is the weight scalar for system f4_{E5}

W5_{E5} is the weight scalar for system f5_{E5}

Bias Vector (Bi_{E5})

B1_{E5} is the bias vector for System f1_{E5}

B2_{E5} is the bias vector for System f2_{E5}

B3_{E5} is the bias vector for System f3_{E5}

B4_{E5} is the bias vector for System f4_{E5}

B5_{E5} is the bias vector for System f5_{E5}

Error Adjustment Factor for Back Propagation (Zi_{E5})

Z1_{E5} is the Error Adjustment Factor for W1_{E5}

Z2_{E5} is the Error Adjustment Factor for W2_{E5}

Z3_{E5} is the Error Adjustment Factor for W3_{E5}

Z4_{E5} is the Error Adjustment Factor for W4_{E5}

Z5_{E5} is the Error Adjustment Factor for W5_{E5}

where the Error Adjustment Factor uses the data to adjust the network's weights and thresholds so as to minimize the error in its predictions on the training set. If the network is properly trained, it has then learned to model the (unknown) function that relates the input variables to the output variables, and can subsequently be used to make predictions where the output is not known.

The Centralized Current Passenger and Occupancy Profile Database (408) maintains all the passenger and occupancy profile information and is replicated in real time with similar database image which are part of embedded Video Analytics Layer in the Digital Video Camera System (100). This database is an embedded component in the computing system in Central Command Control Operations Center which maintains and provides updated information in real time related to passenger and occupancy information in various trains which are currently running and expected to run in future time period. The passenger information provides the booking details of the passenger including the seat number, compartment ID and train number and date of travel etc. Information also includes passenger health and physical and medical records (for special needs) on up to the minute basis based on the occupancy and tickets issued for the train Journey. All the trains running on various rail routes send and receive updated real time data and the passenger information and occupancy location information within the train is also transmitted to the central using the video Cameras, RFID, Wireless LAN, Mobile Phones etc at any given point of the time to the Central Command Control Computation System (300) through communication network. This database also provides the static vulnerability profile of the train which is computed based on various factors such as train speed, train maintenance status, total number of compartments in the train etc. that may affect the train vulnerability. This database is used by various other Control Guidance Systems (411), Centralized Disaster Vulnerability Analytics (417) and Track Maintenance Requirement Analytics (410) for computing the centralized analytics related to disaster vulnerability. This Analytic Rules Engine is a data mining rules engine which is capable of autonomous learning from previous operational records database and passenger information in order to calibrate the specifications evaluation of rules constructs based on the leanings attained. This database communicates with other components which are part of the Train Onboard Computer System (200) and embedded Video Analytics Layer in the Digital Video Camera System (100) using Communication Network synchronized in real time.

The Central Control Guidance System (411) is a centralized control rules engine with various control system rules related to various train control profiles based on operational, structural and environmental, geographic variables and parameters for various railway network segments which includes railway track operational and reliability profiles in the railway network, the control systems are enabled through fuzzy logic, artificial neural network, pattern recognition and other learning machines based system to provide near real time control guidance to the on board computers in moving trains to meet the reliability, safety operational requirement of train running on railway tracks. The central control system provides additional inputs/triggers based on climatic and other geophysical variables to the Train Onboard Computer System (200). The Central Control Guidance System (411) is a centralized rules engine system and databases which is synchronized with various on board systems in the running trains using Communication Network. The Central Command Control System (300) also maintains the early reliability prediction alerts/triggers to indicate various events related to safety, maintenance and train operating plans.

The Centralized Operations Control Simulation and Learning (412) module uses output from various analytics components which are part of the Video Analytics Layer in the Digital Video Camera System (100) and Train Onboard Computing System (200). This module is an embedded component in the computing systems in Central Command Control Operations Center. Using various master operational safety specification, technical safety speciation and reliability specification with associated evaluation rules constructs. This module is essentially responsible for computing various command control operations analysis including simulated “What If” scenarios of various control systems. The Analytic Rules Engine is a data mining rules engine which is capable of autonomous learning from previous operational records information in order to calibrate the specifications evaluation rules constructs based on the learnings attained. This module provides control guidance to Train Onboard Computer Systems (200) and also communicates with other components which are part of the Train Onboard Computer System (200) and also the embedded Video Analytics Layer in the Digital Video Camera System (100) using Communication Network synchronized in real time. The Centralized Operations Control Simulation and Learning (412) additionally performs comprehensive and deeper level of analytics using data mining and knowledge discovery techniques and artificial neural network, fuzzy logic and expert system from previous train runs and historical information from the stored database at Central Command Control Operations Center

The Centralized Engineering Measurement Analytics Master Rules Engine (413) module uses output from various analytics components which are part of the Digital Video Camera System (100) and Train Onboard Computing System (200). This module is an embedded component in the computing system in Central Command Control Operations Center which provides master operational safety specification, technical safety and reliability specification with associated evaluation rules constructs. The specifications are unique derivative of individual train system and railway track segments of particular rail routes. The output from this system is used by various other Central Control Guidance System (411) and Centralized Disaster Vulnerability Analytics (417) and Central Maintenance Requirement System (420) for computing the centralized analytics. This Analytic Rules Engine is a data mining rules engine which is capable of learning from previous operational records database and calibrate the specifications evaluation rules constructs based on the leanings. The module communicates with other components which are part of the Train Onboard Computer System (200) and embedded Digital Video Analytics Layer in the Digital Video Camera System (100) using wide area communication network synchronized in real time. The Centralized Engineering Measurement Analytics Master Rules Engine (413) additionally performs comprehensive and deeper level of analytics using data mining and knowledge discovery techniques and artificial neural network, fuzzy logic and expert system from previous train runs and historical information from the stored database at Central Command Control Operations Center.

The Centralized Operational Safety Analytics Rules Engine (414) module is a centralized rail network safety measurement and rules database related to various operational measurement such as vibration, speed, noise and other associated parameters of railway track segment while the train is running in the railway network. This module uses output from various analytics components which are part of Video Analytics Layer in the Digital Video Camera System (100) and Train Onboard Computing System (200). This module is an embedded component in the computing systems in Central Command Control Operations Center which performs master operational safety analytics, technical safety and reliability analytics and associated evaluation rules constructs. The analytics constructs are unique derivative of individual train and track systems based on the operational mission. The output from this module is used by various other Central Control Guidance System (411) and Central Disaster Vulnerability Analytics (417) and Central Emergency Maintenance Requirement System (420) for computing the centralized analytics. This Analytic Rules Engine is a data mining rules engine which is capable of learning from previous operational records database and calibrate the specifications evaluation rules constructs based on the leanings. This module communicates and inter operate with other components which are part of the Train Onboard Computer System (200) embedded Video Analytics Layer in the Digital Video Camera System (100) using Wide Area Communication System synchronized in real time. The Centralized Operational Safety Analytics Rules Engine (414) additionally performs comprehensive and deeper level of analytics using data mining and knowledge discovery techniques and artificial neural network, fuzzy logic and expert system from previous train runs and historical information from the stored database at Central Command Control Operations Center.

The Centralized Railway Track Segments Inventory Database (416) module is a centralized master database system maintained at Central Command Control Operations Center. This database maintains detailed information about the entire track segment and the associated assembly and components. This database is replicated in real time with similar database images which are part of embedded Video Analytics Layer in the Digital Video Camera System (100) and Train Onboard Computing System (200). This database is an embedded component in the computing systems in Central Command Control Operations Center which maintains and provides updated information in real time related to track segment and associated systems inventory in various trains which are currently running and expected to run in future time period. This database is used by various other Control Guidance System (411) and Centralized Disaster Vulnerability Analytics (417) and Centralized Maintenance Requirement System (420) for computing the centralized analytics related to disaster vulnerability. This Analytic Rules Engine is a data mining rules engine which is capable of autonomous learning from previous operational records information in order to calibrate the specifications evaluation rules constructs based on the leanings attained. This database communicates with other components which are part of the Train Onboard Computer System (200) and embedded Video Analytics Layer in the Digital Video Camera System (100) using Wide Area Communication System synchronized in real time.

The Centralized Disaster Vulnerability Analytics (417) module uses output from various analytics components in the Digital Video Camera System (100) and Train Onboard Computing System (200). This module is an embedded component in the computing system in Central Command Control Operations Center which performs centralized analytics on disaster vulnerability of the train using various operational safety analytics, technical safety and reliability analytics and associated evaluation rules constructs. The analytics constructs are unique derivative of individual train system and railway track segments of particular rail routes. The output from this module is used by various other Central Control Guidance System (411) and Central Disaster Vulnerability Analytics (417) and Centralized Maintenance Requirement System (420) for computing the centralized analytics. Additionally Centralized Disaster Vulnerability Analytics (417) computes the Disaster Vulnerability of the train from pre-stored disaster information using pre-stored obstruction object images, pre-stored disaster scene images and pre-stored disaster patterns along with associated disaster vulnerabilities in order to quickly identify and assess the disaster vulnerability levels. This Analytic Rules Engine is a data mining rules engine which is capable of learning from previous operational records database and calibrate the specifications evaluation rules constructs based on the leanings. This module communicates and inter operates with other components which are part of the Train Onboard Computer System (200) embedded Video Analytics Layer in the Digital Video Camera System (100) using Communication Network synchronized in real time. Based on the analytics performed by various preliminary analytics and advanced analytics modules, the system sends a trigger to the Centralized Command Control Computation System (300) for centralized analytics using artificial neural networks. The Centralized Disaster Vulnerability Analytics (417) additionally performs comprehensive and deeper level of analytics using Data Mining and knowledge discovery techniques and artificial neural network, fuzzy logic and expert system from previous train runs and historical information from the stored database at Central Command Control Operations Center. When the Centralized Disaster Vulnerability Analytics (417) anticipates an emergency situation upon aggregating the analytic output from various lower level systems, it automatically triggers disaster alerts to the Train On Board Computation System (200) to take necessary measures to avoid a potential accident. The disaster alert is also transmitted automatically to various associated disaster management agencies of the potential disaster event along with disaster characteristics to enable said disaster management agencies employ appropriate and timely rescue and evacuation operations based on the assessment of the disaster vulnerability. The disaster management agencies may include governmental and non governmental agencies that can provide onsite rescue operations to the disaster affected people and help in relief thereupon. The disaster management agencies may include at least one of a police department, a fire department, a hospital, a local government, a state government, a an NGO, a private relief organization, a volunteer organization, or an individual that can provide onsite rescue and management operations to the disaster affected people and help in relief thereupon.

In case the disaster relates to derailment of the train over a tunnel, the disaster characteristics may include critical information related to the event such as expected impact momentum, nature of crash impact to the train with tunnel walls, number of coaches that shall be affected most and the number of most vulnerable people such as infants, children, females, aged or disabled persons who may be affected most by the disaster.

In case the disaster relates to the derailment in a city over-bridge, the disaster characteristics may include critical information related to the compartments which are vulnerable to falling off the bridge with impact momentum, nature of fall of compartments, the number of coaches that may be affected most and the number of most vulnerable people such as infants, children, females, aged or disabled persons who shall be affected most by the disaster.

In case the disaster relates to the derailment of the train over a river bridge, the disaster characteristics may include critical information related to compartments which are vulnerable to falling into river with impact momentum, nature of fall of compartments into the river, number of coaches that may be affected most and the number of most vulnerable people such as infants, children, females, aged or disabled persons who shall be affected most by the disaster.

In case the disaster relates to the derailment of the train over a high mountain bridge, the disaster characteristics may include critical information related to compartments which are vulnerable to falling deep into the mountain valley with impact momentum, nature of falls of the compartments into the valley, fall height, number of coaches that may be affected most and the number of most vulnerable people such as infants, children, females, aged or disabled persons who shall be affected most by the disaster.

The Track Maintenance and Serviceability Database (418) is a centralized master database system maintained at Central Command Control Operations Center. This database maintains all the track segment maintenance and serviceability detail records. This database is replicated in real time with similar database images which are part of embedded Video Analytics Layer in the Digital Video Camera System (100) and Train Onboard Computing System (200). This database is an embedded component in the computing systems in Central Command Control Operations Center. This database maintains and provides updated information in real time related to maintenance and serviceability of various tracks segments in the rail route which are currently in use by the trains and assigned to be used in future time. This database also provides the static vulnerability profile of the train which is computed based on the Train Systems Inventory profile with the railway track maintenance and reliability information. This database is used by various other Control Guidance System (411) and Centralized Disaster Vulnerability Analytics (417) and Track Maintenance and Serviceability Analytics (410) for computing the centralized analytics related to disaster vulnerability. The Analytic Rules Engine is a data mining rules engine which is capable of autonomous learning from previous operational records database and passenger information in order to calibrate the specifications evaluation of rules constructs based on the leanings attained. This database communicates with other components which are part of the Train Onboard Computer System (200) and embedded Video Analytics Layer in the Digital Video Camera System (100) using Communication Network synchronized in real time.

The Centralized Automatic Emergency Control System (419) is essentially responsible for triggering Onboard Disaster Rescue and Recovery System (422) based upon the output received from the Centralized Operational Safety Analytics (206) which evaluates operational safety and disaster vulnerability of the passengers inside the train. The system automatically activates Onboard Disaster Rescue and Recovery System (422) based on the passenger disaster vulnerability profile for immediate rescue during emergency. The Onboard Disaster Rescue and Recovery System (422) automatically computes Disaster Vulnerability Control Zones based on the impact assessment of Disaster Vulnerability at different locations on the railway track. The Control Zones are computed associated with level of impact and magnitude of the disaster. For example if there exists a potential danger at a distance of 1 KM from the current location of the train, the Control Zones are computed as if the train stops before 600-900 Meters there is no disaster impact as all the compartments would stop before disaster location. If the train stops at 900-1200 the impact is little as some compartments would cross over the disaster location etc. The Control Zones are computed with respect to the contextual factors such as existence of bridge, mountain range, river etc. in the railway track. Control Zones provides guidance for avoiding and minimizing the disaster impact. Further the control zone computation considers various other factors not limited to geographical, environmental and climatic conditions. Based on the disaster Vulnerability Zones, the Railway Signal Display System automatically and dynamically updates the information across all the rail routes in order to alert the other trains with the disaster Vulnerability Information with location profile and the nature of impending disaster vulnerability etc.

The Centralized Emergency Maintenance Requirement System (420) is essentially responsible for evaluating the various maintenance analytics using the video analytics and investigation video stream to assess various Emergency Maintenance Requirements in the tracks and train systems which are related to safety of the train and railway track. Additionally Centralized Emergency Maintenance Requirement System (420) computes the emergency maintenance requirements from pre-stored defect modeling information using pre-stored defective images, pre-stored defect patterns and associated emergency maintenance requirements in order to quickly identify and assess the disaster vulnerability levels due to maintenance issues. Based on the emergency maintenance requirements respective railway signal display systems automatically and dynamically updated across the rail route in the railway network in order to provide warning and alerts the other trains with the emergency maintenance requirement information with location profile and the nature of impending disaster vulnerability etc.

The Centralized Train Inventory Master Database (421) maintains detailed database of all the trains in the centralized network and the associated assembly and components related information. This database is replicated in real time with similar database images which are part of embedded Video Analytics Layer in the Digital Video Camera System (100) and Train Onboard Computing System (200). This database is essentially responsible for maintaining and providing updated information in real time related to inventory system in various trains in a network which are currently running and expected to run in future time period. The Centralized Train Inventory Master Database (421) also provides details including the component number, compartment ID and train number and date of running of each train running in the network. This database also provides the static Train Disaster Vulnerability Profile which is computed based on the train systems inventory profile with the railway track maintenance and reliability information. This database is used by various other Control Guidance Systems (411) and Centralized Disaster Vulnerability Analytics (417) and Central Track Maintenance Analytics (409) for computing the centralized analytics related to disaster vulnerability of the train. The Analytic Rules Engine is a data mining rules engine which is capable of autonomous learning from previous operational records database and passenger information in order to calibrate the specifications evaluation of rules constructs based on the leanings attained. This database communicates with other components which are part of the Train Onboard Computer System (200) and embedded Video Analytics Layer in the Digital Video Camera System (100) using Communication Network synchronized in real time.

The Onboard Disaster Rescue and Recovery System (422) activates Response Rescue Functions based on the output from the control zone during a disaster. The Response Rescue Functions may include the application of collision impact reduction buffering system in the train for reducing the impact of sudden break and reducing the harm to the passengers in case the system suddenly detects an obstruction on the railway track or the adjacent tracks that may cause a serious accident. By application of collision impact reduction buffering system, the overall impact of a sudden break reduces to a great extent and prevents passengers from potential damage.

When the system detects a potential danger, an announcement of the accident or disaster may also be made in all the compartments of the train for alerting the passengers of the accident and help them take action to rescue themselves. The system automatically shuts down all the electrical systems inside the train for prevention of fire due to shortcut. In case any infants are present inside the train (which is calculated based on the profile of the passengers) the infant protection system is activated immediately. The train windows may automatically break or emergency outlets may be opened automatically to enable easy exit and rescue of the passengers from the train. The system may also automatically activate anti skidding friction system of the train. In case a sudden break is applied to the train, the system may deploy air bags in all the seats for prevention of damage to the passengers from sudden break or movement of train. In case fire breaks out inside the train, the system may automatically activate fire extinguishing system to prevent damage caused due to fire inside the train. In case there is a train collision, the system may activate collision impact reduction system to prevent and reduce damage to the passengers due to sudden jerk. The system may also release first aid kits for providing immediate first aid to the wounded passengers.

### EXAMPLES

a) The potential Disaster Vulnerability Assessment of various railway routes in the railway network based on environmental, climatic and geographic conditions based on the week of the month and month of the year. As an example during the snow season, the disaster vulnerability of railway track in the railway segment would be different as compared to summer or spring season. The disaster vulnerability is computed based on the past climatic, geographic and environmental statistics and the same is computed based on past accident records in a particular region.

b) The maintenance centered Disaster Vulnerability is mainly based on the environmental, climatic and geographic conditions of a particular region. For example, during the summer season, the railway line might expand due to increased temperature as compared to winter. In another scenario, if the railway track is near the coastal line, the corrosion of the tracks may take place which is major factor to be taken into consideration for performing disaster vulnerability analysis and the same is computed based on the past accident records of other trains in the same geographical region.

c) The Emergency Response Management Preparation for Disaster Vulnerability is also based on the environmental, climatic and geographic conditions prevailing in the past few days, months or years and also the conditions expected in due course of time. For example, if a train is expected to pass through a rail route in a mountain region, the emergency management procedure will be different and more difficult as compared to a train passing through the plain region. Similarly in case the train is expected to pass through the rail route in a snow or rainy season, the emergency management procedure is very different.

d) In another example the Central Command Control Computation System (300) may also provide an early information or update, at the time of booking the train, to respective passengers based on their profile using the a) , b) and c) in order to provide suggestions.

e) The Central Command Control Computation System (300) may record various Operational and Safety Analytics of various trains in various rail networks and develop a comprehensive model of maintenance engineering, train scheduling and right train system selection.

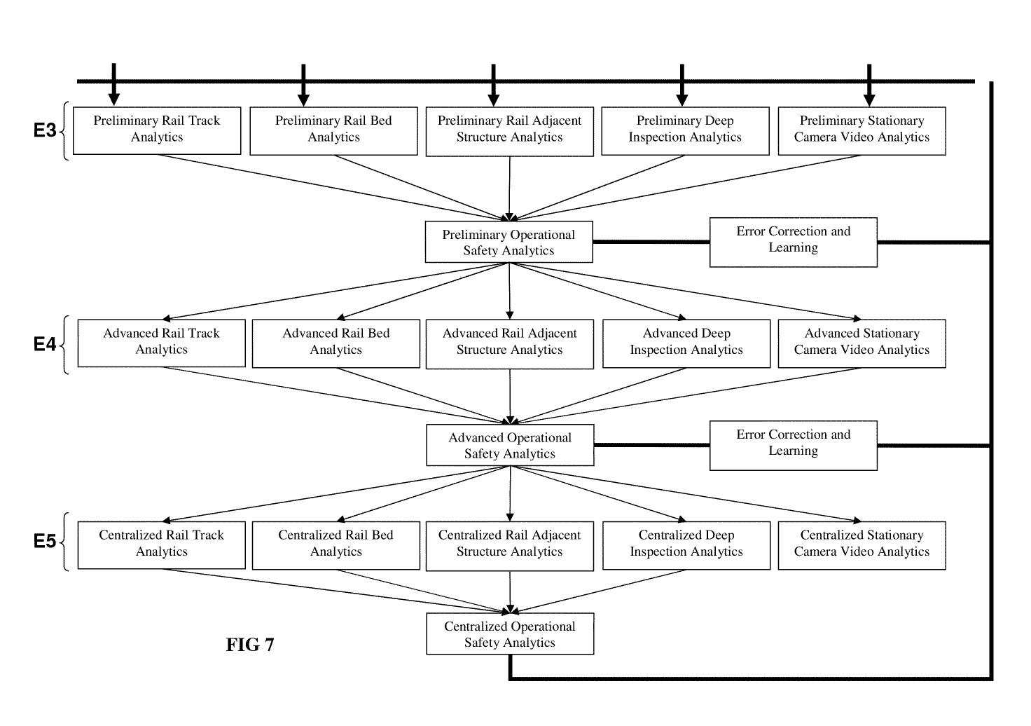

FIG. 7 illustrates the analytical model for real time rail disaster vulnerability assessment and rescue guidance using video computational analytics in accordance with one embodiment of the invention.

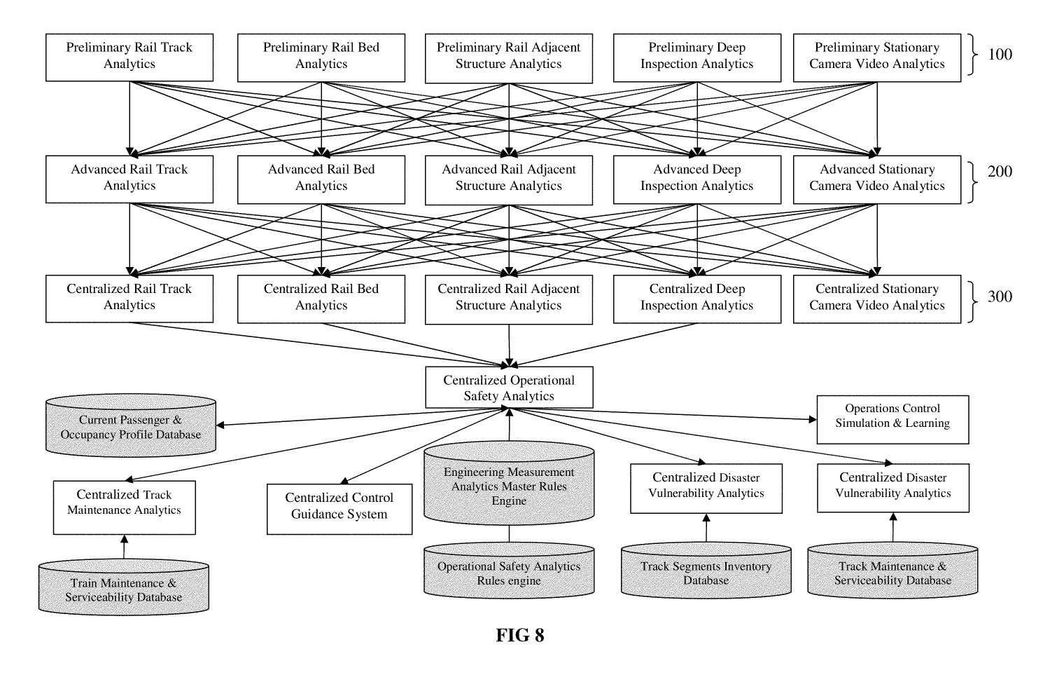

FIG. 8 illustrates the analytical model for real time rail disaster vulnerability assessment and rescue guidance using video computational analytics in accordance with one embodiment of the invention.

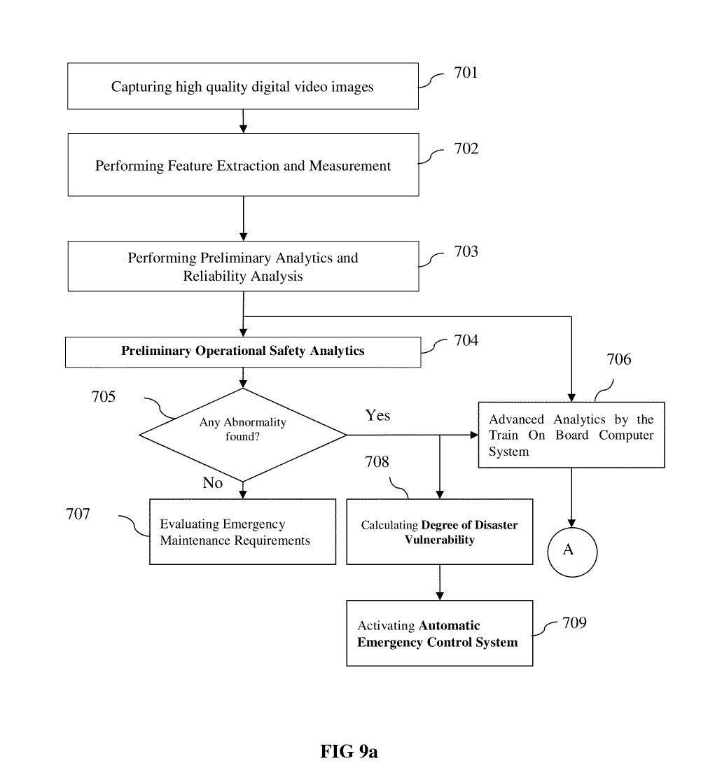

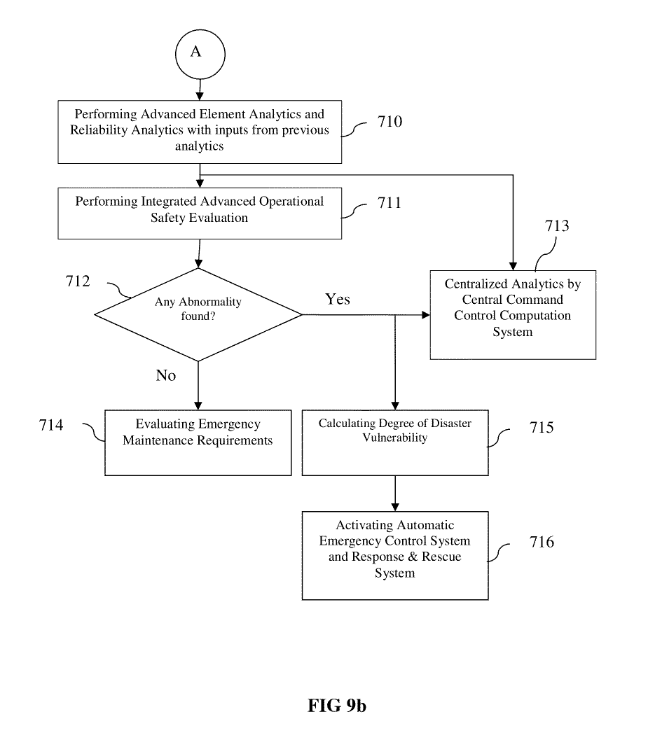

FIGS. 9a and 9b illustrate the method of real time rail disaster vulnerability assessment and rescue guidance using video computational analytics in accordance with one embodiment of the invention. In this embodiment, the method for real time rail disaster vulnerability assessment and rescue guidance using video computational analytics is described with respect to the modules defined in earlier sections.

At step 701, the video cameras in the Digital Video Camera System (100) mounted on the train capture high definition video images of the railway track and other components such as railway beds and foundations systems, railway track adjacent environment using plurality of high speed video cameras mounted on the train in real time.

At step 702, the embedded analytic systems inside the video cameras in the Digital Video Camera System perform various feature extraction and measurements using neural network, fuzzy logic and expert systems.

At step 703, the system performs Preliminary Analytics using “Finite Element Methods” and Reliability Analysis with an objective of operational safety and disaster vulnerability from the feature extraction and measurements received from step 702. The embedded analytic systems in the video cameras in the Digital Video Camera System (100) perform various analytics such as Preliminary Rail Track Analytics (101), Preliminary Rail Bed feature Analytics (102), Preliminary Adjacent Structure Analytics (103), Preliminary Deep Inspection Analytics (104) and Preliminary Stationary Video Analytics (105) on the output received from the video cameras.

At step 704, the Preliminary Operational Safety Analytics are performed by the system based on the preliminary analytics performed by the embedded systems at step 703. The analytics are performed to identify and classify the immediate threat or vulnerability to the train by aggregating the analytical input from step 703.

At step 705, a check is made whether an abnormality is observed in the preliminary analytics performed at step 703.

In case the result of the check made at step 705 is affirmative which indicates the existence of an abnormality in the rail track and adjacent structures, the control transfers to step 706, where further in-depth advanced analytics are performed based on the data available onboard and data from previous train runs. The Onboard Computer System (200) is configured to detect the abnormalities in the railway track and adjacent structure even in case the Digital Video Camera System (100) was unable to detect the same. The Train Onboard Computer system (200) further performs various analytics by using additional inputs such as train speed, vibration in the train, wind speed, rail segment the train is passing through etc. using various neural network based computations under different weightages and collective output of multiple analytics factors at the Preliminary Element Analytics.

Since the Digital Video Camera System (100) has a limited amount of information as it records the video images of the track the train is passing through. The Digital Video Camera System (100) system doesn't take into consideration various factors related to train condition, passenger profile and other related geographical factors that may contribute to a train disaster. The computing devices in the Train Onboard Computer System (200) are configured to store databases of the information related to the train as well other important information that may affect the disaster vulnerability of the train at a particular time. Such information includes some vital real time profile of each passenger, information about all the systems and sub systems inside a train, all the maintenance aspects of the train compartment and associated systems, all the maintenance and services ability records related to railway track and associated systems, various records of track segment profiles of various tracks segments such as track position in relation with GPS, geographical characteristics, operational characteristics, and structural characteristics on a given rail route.

In case the result of the check made at step 705 is negative which means there is no abnormality found in the rail track and adjacent structures, the control transfers to step 707 where the system evaluates emergency maintenance requirements of the railway track by performing Preliminary Emergency Maintenance Analytics (112) FIG. 4 to evaluate various immediate maintenance, repair, deep inspection and investigation requirement and assess various emergency maintenance requirements in the tracks and train systems which are related to safety of the train and railway track. Alert for maintenance is triggered based upon the intensity of the irregularity detected.

At step 708, while shifting the control to Train Onboard Computer System (200) in case of existence of any abnormality, the system simultaneously calculates the degree of disaster vulnerability of the train and also the impact on continuous time, with respect to the abnormality thus observed. At step 709, the system activates the Automatic Emergency Control System and also activates the Response and Rescue System in case the output of the computation at step 708 exceeds a predetermined threshold value. At step 710, the Train Onboard Computer System (200) performs Advanced Element Analytics using “Finite Element Methods”, and Reliability Analysis with contextual measurements of various interrelated railway systems with additional input of previous analytics and previous reported anomalies or train systems and other accident records in the specific railway segments to increase the accuracy of the evaluation.

At step 711, the Train Onboard Computer System (200) performs Advanced Operational Safety Evaluation to discover and classify more deeper level of threat or vulnerability assessment using additional real-time train data comprising train speed, vibration in the train, number of compartments in the train, maintenance status of the train, railway segment profile, data from previous train runs and historical information from the stored database maintained by Train Onboard Computer System. The Train Onboard Computer System aggregates multiple analytics factors at Advanced Element Analytics Level using various neural network based computations. At step 712, a check is made whether an abnormality is observed in the Advanced Operational Safety Evaluation performed at step 703. In case the result of the check made at step 712 is affirmative which means that system finds a deviation or abnormality in the advanced analytics performed by Train Onboard Computer System (200), at step 713 the output is transferred to Centralized Analytics by Central Command Control Computation System (00) where more advanced centralized analytics are performed. The Central Command Control Computation System (300) is a centralized information system in a geographical area which is configured to communicate with Digital Video Camera System (100) and the Digital Train Onboard Computer System (200) mounted on each train via communication network. The computing devices at Central Command Control Computation System (300) receive real time data from the Digital Video Camera System (100) and Train Onboard Computer System (200) and store the information in the databases. The information comprises the data related to each train running in the network, as well as other important information that may affect the disaster vulnerability of the train at a particular time and date. The information also includes real time geographic features, climatic and environmental factors and previous records and previous analytics inputs from other trains. The centralized system discovers and classifies deeper level of threat or vulnerability assessment using additional real-time geographic and environmental data comprising real time geographic features and real time environmental factors prevailing in a particular rail route whereby combining environmental factors as well as geographical factors to advanced analytics output that may contribute to a potential disaster and subsequently taking necessary precautionary measures to avoid such disaster. At step 715, while shifting the control to Central Command Control Computation System (300) in case of existence of any abnormality, the system simultaneously calculates the degree of disaster vulnerability of the train and also the impact on continuous time, with respect to the abnormality thus observed. At step 716, the system activates the Automatic Emergency Control System and also activates the Response and Rescue System in case the output of the calculations at step 715 exceeds a predetermined value. In case the result of the check made at step 710 is negative which means there is no deviation or abnormality found in the advanced analytics performed by Train Onboard Computer System (200), the control transfers to step 714 where the system evaluates Emergency Maintenance Requirements of the train.

Automated comparing and analyzing the wear and tear of the object of the Railway Tracks Systems from various identical video images of various successive train runs critical damage and wear and tear pattern may be discovered by video computational analytics using artificial neural network, fuzzy logic and expert system to evaluate the emergency maintenance requirements for the disaster vulnerability due to the wear and tear.

Hence, the invented system provides an efficient system for avoiding a disaster by making real time assessment of a potential disaster and in case the disaster happens, the system ensures minimal damage to the train as well as occupants inside the train by application of a suitable onboard rescue and recovery system based on the disaster vulnerability profile of the passengers inside the train and reduces the damage caused by taking timely and suitable measures. The system automatically transmits alerts to various associated disaster management agencies of the potential disaster event along with disaster characteristics to enable said disaster management agencies employ appropriate and timely rescue and evacuation operations based on the assessment of the disaster vulnerability.

I claim:

1. A system for real time rail disaster vulnerability assessment and rescue guidance using multi-layered video computational analytics, said system comprising:
a. Digital Video Camera System further comprising:
i. plurality of high speed digital video cameras mounted on train for capturing, measuring, computation and performing preliminary analytics of railway track features and adjacent structure using embedded computational video analytics, image processing and artificial neural networks;
ii. plurality of high speed stationary digital video cameras mounted at fixed locations on railway bridges, railway tunnels, railway towers and railway adjacent structure for capturing, measuring, computation and performing preliminary analytics of railway track features and adjacent structure from fixed location using embedded computational video analytics, image processing and artificial neural networks;
iii. high speed digital video camera mounted on unmanned aerial monitoring vehicle for capturing, measuring, computation and performing preliminary analytics of railway track features and adjacent structure using embedded computational video analytics, image processing and artificial neural networks,
wherein said Digital Video Camera System automatically computes degree of disaster vulnerability from collective analysis of output from said video cameras and in case degree of disaster vulnerability exceeds predetermined threshold value, said system triggers a preliminary disaster alert to a Preliminary Automatic Emergency Control System inside the train to take immediate precautionary measures to avoid potential disaster while simultaneously activating On Board Rescue and Response System whereby avoiding the damage to train and occupants and considerably reducing the rescue response time by immediately activating rescue and response system and also transmitting disaster alerts for further confirmation from advanced systems in the network;
b. Train Onboard Computer System mounted inside each train, said Train Onboard Computer System having plurality of high speed computing devices for additionally performing comprehensive and deeper level of advanced analytics on said preliminary analytics output from said Digital Video Camera System using real-time train data contributing to a potential disaster;
wherein said Train Onboard Computer system automatically computes degree of disaster vulnerability from collective analysis of output from said Digital Video Camera System and in case degree of disaster vulnerability exceeds predetermined threshold value, said system triggers an advanced disaster alert to a Advanced Automatic Emergency Control System inside the train to take immediate precautionary measures to avoid potential disaster while simultaneously activating On Board Rescue and Response System and in case degree of disaster vulnerability is below said predetermined threshold value, the advanced analytics output is transmitted to train on board computer system for more detailed centralised analytics whereby performing collective analysis of an abnormality by taking into consideration train related factors as well as historical information of the train from the stored databases contributing to a disaster;
c. Central Command Control Computation System located at a central location in a railway network and connected to said Train Onboard Computer System via communication network, said Central Command Control Computation System having plurality of network connected high speed computing devices configured to additionally perform detailed centralized analytics on said advanced analytics output using real-time geographic and environmental data contributing to a potential disaster,
wherein said Central Command Control Computation System automatically calculates the degree of disaster vulnerability from collective output and triggers a centralised disaster alert to the operator of the train of the risk of an accident involving said train in case degree of disaster vulnerability exceeds threshold value, said Central Command Control Computation System also activates on board rescue and response system upon detecting a serious disaster whereby performing collective analysis of an abnormality by taking into consideration geographic and environmental data contributing to a potential disaster.

2. The system as claimed in claim 1, wherein said video cameras in said Digital Video Camera System are configured to capture real time videos and images of railway track system, railway beds, railway foundations, railway track adjacent structure from a running train.

3. The system as claimed in claim 1, wherein said video cameras in said Digital Video Camera System have embedded analytics components configured to perform preliminary analytics on the track components based on video images captured by said video cameras and are configured to automatically detect the abnormalities in the railway track whereby immediately triggering disaster alert in case of any abnormality detected in the railway track and avoiding a potential disaster instantly.

4. The system as claimed in claim 1, wherein in case degree of disaster vulnerability computed by Digital Video Camera System is below said predetermined threshold value, the preliminary analytics output is transmitted to said Train On Board Computer System for in-depth advanced analytics.

5. The system as claimed in claim 1, wherein said video cameras in said Digital Video Camera System are configured to transmit and exchange data among said Train Onboard Computer System and said Central Command Control Computation System using communication network in the railway network.

6. The system as claimed in claim 1, wherein a simulation system for operational training and education is provided that uses stored video images, said preliminary analytics, said advanced analytics and said centralized analytics from train runs across said railway network for the purpose of training and educational support to railway operational and engineering personnel.

7. The system as claimed in claim 1, wherein said Train Onboard Computer System receives output from said Digital Video Camera System and Train Onboard Computer System mounted on other trains via real time communication network whereby providing intercommunication among all the train in the railway network.

8. The system as claimed in claim 1, wherein in case degree of disaster vulnerability computed by said Digital Video Camera System is below said predetermined threshold value, the output from said preliminary analytics is also sent to emergency maintenance requirement system for rectification of the detected abnormality in the rail route whereby ensuring complete safety of the rail route for future train runs.

9. The system as claimed in claim 1, wherein said real-time train data further comprises:
a. railway track segments inventory database storing data related to segment profiles of various tracks segments;
b. engineering measurement analytics rule engine storing data related to engineering safety specifications;
c. train maintenance and serviceability database storing data related to maintenance and serviceability of the train and associated systems;
d. track maintenance and serviceability master database storing data related to maintenance and serviceability records of railway track and associated systems;
e. railway track segments inventory database storing data related to track segment profiles of various rail route tracks segments such as track position, geographical characteristics, operational characteristics, structural characteristics, environmental characteristics on a given rail route;
f. previous records/analytics outputs from the other trains;
g. train characteristics storing data related to current train speed, vibration in the running train, total number of compartments in the train, data from previous train runs and historical information from the stored database maintained by said Train Onboard Computer System,
whereby considering train related factors contributing to an accident or disaster in addition to track related abnormalities.

10. The system as claimed in claim 1 and claim 9, wherein a real time train vulnerability profile by Train On Board Computer System for each train is computed based on said real time train data wherein said train vulnerability profile is constantly updated depending upon variations in these parameters.

11. The system as claimed in claim 1, wherein a real time passenger vulnerability profile for each occupant inside the train is computed based on the following parameters:
a. seat number of the passenger;
b. medical condition of the passenger;
c. physical condition of the passenger;
d. age and sex of the passenger;
e. train compartment number where the passenger is located;
wherein said passenger vulnerability profile is constantly updated depending upon variations in these parameters.

12. The system as claimed in claim 1, claim 10 and claim 11, wherein said degree of disaster vulnerability by Train On Board Computing System is computed by collective analysis of said advanced analytics, said real time train vulnerability profile and said real time passenger vulnerability profile.

13. The system as claimed in claim 1, wherein in case degree of disaster vulnerability computed by Train Onboard Computer System is below said predetermined threshold value, the output from said advanced analytics is also sent to emergency maintenance requirement system for rectification of the detected abnormality in the rail route for ensuring complete safety of the rail route for future train runs.

14. The system as claimed in claim 1, wherein said real-time geographical and environmental data further comprises real time geographic features prevailing in the rail route and real time environmental and climatic factors prevailing in the rail route, information about other trains in the same rail route having potential to collide with running train whereby combining environmental factors and climatic factors as well as geographical factors to advanced analytics output that may contribute to a potential disaster and subsequently taking necessary precautionary and preventive measures to avoid such disaster.

15. The system as claimed in claim 1, claim 9 and claim 14, wherein a real time train vulnerability profile by central command control computation system for each train is computed based on said real time train data and said real-time geographical and environmental data wherein said train vulnerability profile is constantly updated depending upon variations in the parameters constituting said real time train data and said real-time geographical and environmental data.

16. The system as claimed in claim 1, claim 11 and claim 15, wherein said degree of disaster vulnerability by central command control computation system is computed by collective analysis of said centralised analytics, said real time train vulnerability profile and said real time passenger vulnerability profile.

17. The system as claimed in claim 1, wherein in case degree of disaster vulnerability computed by Central Command Control Computation System is below said predetermined threshold value, the output from said centralised analytics is also sent to centralized emergency maintenance system for rectification of the detected abnormality in the rail route for ensuring complete safety of the rail route for future train runs.

18. The system as claimed in claim 1, wherein said Digital Video Camera System, Train Onboard System and Central Command Control Computation System perform static and dynamic measurements related to railway tracks and perform comparative analysis against pre-defined rail track measurements using computational video analytics, image processing and artificial neural networks and fuzzy logics and exert system algorithms to evaluate the real time railway disaster vulnerability potential of the train.

19. The system as claimed in claim 1, wherein while triggering said disaster alert, the system communicates potential disaster scenarios along with associated impacts immediately to Control Guidance System inside said train and other respective trains in said railway network whereby avoiding further damage to the trains passing through or near the disaster location.

20. The system as claimed in claim 1, wherein upon receiving said disaster alert, said Control Guidance System inside the train automatically transmits alerts to various disaster management agencies of the potential disaster event along with disaster characteristics to enable said disaster management agencies employ appropriate and timely rescue and evacuation operations based on the assessment of the disaster vulnerability.

21. The system as claimed in claim 1, wherein said Onboard Disaster Rescue and Recovery System computes control zones based on impact assessment of disaster vulnerability at different locations on the railway route for providing guidance to avoid and minimize the disaster impact.

22. The system as claimed in claim 21, wherein based on said control zones, said system automatically and dynamically updates the information, including location profile and nature of impending disaster, across all the rail routes in order to alert other trains of the disaster.

23. The system as claimed in claim 1, wherein said Onboard Disaster Rescue and Recovery System activates Response Rescue Functions based on the output from said control zones wherein said Response Rescue Functions further comprise at least one of:
a. application of collision impact reduction buffering system in the train for reducing the impact of sudden break and reducing the harm to the passengers;
b. announcement of the mishappening in all the compartments whereby alerting passengers of the accident and help them take action to rescue themselves;
c. shutting down of the electrical systems inside the train for prevention of fire due to shortcut;
d. activation of infant protection system;
e. automatic breakage of train windows for easy exit from the train;
f. automatic release of emergency outlets for immediate rescue of the passengers from the train;
g. activation of anti skidding friction system inside the train;
h. deployment of air bags for prevention of damage to the passengers from sudden break or movement of train;
i. activation of fire extinguishing system to prevent damage caused due to fire inside the train;
j. application of collision impact reduction system to prevent and reduce damage due to sudden collision;
k. release of first aid kit for providing immediate first aid to wounded passengers.

24. A method for real time rail disaster vulnerability assessment and rescue guidance using video computational analytics, said method comprising steps of:
a. capturing digital video images of railway track of the railway track;
b. performing feature extraction and measurement on said video images of railway track;
c. performing preliminary analytics and reliability analytics on said video images of railway track to identify and classify immediate threat or vulnerability to train;
d. computing degree of disaster vulnerability from collective analysis of preliminary analytics:
i. in case degree of disaster vulnerability exceeds predetermined threshold value, triggering a preliminary disaster alert to take immediate precautionary measures to avoid potential disaster while simultaneously activating On Board Rescue and Response System;
ii. in case degree of disaster vulnerability is below said predetermined threshold value, transmitting said preliminary analytics output to train on board computer system for in-depth advanced analytics,
whereby avoiding the damage to train and occupants and considerably reducing the rescue response time by immediately activating rescue and response system and also transmitting disaster alerts for further confirmation from advanced systems in the network;
e. performing advanced analytics on the output by using said preliminary analytics output and real-time train data contributing to a potential disaster,
f. computing degree of disaster vulnerability from collective analysis of advanced analytics:
i. in case degree of disaster vulnerability exceeds predetermined threshold value, triggering a advanced disaster alert to take immediate precautionary measures to avoid potential disaster while simultaneously activating On Board Rescue and Response System;
ii. in case degree of disaster vulnerability is below said predetermined threshold value, transmitting said advanced analytics output to train on board computer system for centralised analytics,
whereby performing collective analysis of an abnormality by taking into consideration train related factors as well as historical information of the train from the stored databases contributing to a disaster;
g. performing centralised analytics on the output by using said advanced analytics output and real-time geographic and environmental data contributing to a potential disaster;
h. computing degree of disaster vulnerability from collective analysis of centralized analytics and in case degree of disaster vulnerability exceeds predetermined threshold value, triggering centralized disaster alert to take immediate precautionary measures to avoid potential disaster while simultaneously activating On Board Rescue and Response System whereby performing collective analysis of an abnormality by taking into consideration geographic and environmental data contributing to a potential disaster.

25. The method as claimed in claim 24, wherein in case degree of disaster vulnerability from collective analysis of preliminary analytics is below said predetermined threshold value, the output from said preliminary analytics is also sent to emergency maintenance requirement system for rectification of the detected abnormality in the rail route whereby ensuring complete safety of the rail route for future train runs.

26. The method as claimed in claim 24, wherein said real-time train data further comprises:
a. railway track segments inventory database storing data related to segment profiles of various tracks segments;
b. engineering measurement analytics rule engine storing data related to engineering safety specifications;
c. train maintenance and serviceability database storing data related to maintenance and serviceability of the train and associated systems;
d. track maintenance and serviceability master database storing data related to maintenance and serviceability records of railway track and associated systems;
e. railway track segments inventory database storing data related to track segment profiles of various rail route tracks segments such as track position, geographical characteristics, operational characteristics, structural characteristics, environmental characteristics on a given rail route;
f. previous records/analytics outputs from the other trains;
g. train characteristics storing data related to current train speed, vibration in the running train, total number of compartments in the train, data from previous train runs and historical information from the stored database maintained by said Train Onboard Computer System,
whereby considering train related factors contributing to an accident or disaster in addition to track related abnormalities.

27. The system as claimed in claim 24 and claim 26, wherein a real time train vulnerability profile for each train is computed based on said real time train data and said train vulnerability profile is constantly updated depending upon variations in these parameters.

28. The method as claimed in claim 24, wherein said a real time passenger vulnerability profile for each occupant inside the train is computed based on the following parameters:
a. seat number of the passenger;
b. medical condition of the passenger;
c. physical condition of the passenger;
d. age and sex of the passenger;
e. train compartment number where the passenger is located;
f. type of the disaster and the impact magnitude of the disaster,
wherein said passenger vulnerability profile is constantly updated depending upon variations in above parameters.

29. The method as claimed in claim 24, claim 27 and claim 28, wherein said degree of disaster vulnerability by Train On Board Computing System is computed by collective analysis of said advanced analytics, said real time train vulnerability profile and said real time passenger vulnerability profile.

30. The method as claimed in claim 24, wherein in case degree of disaster vulnerability from collective analysis of advanced analytics is below said predetermined threshold value, the output from said advanced analytics is also sent to emergency maintenance requirement system for rectification of the detected abnormality in the rail route whereby ensuring complete safety of the rail route for future train runs.

31. The method as claimed in claim 24, wherein said real-time geographical and environmental data further comprises real time geographic features prevailing in the rail route and real time environmental factors prevailing in the rail route, information about other trains in the same rail route having potential to collide with running train whereby combining environmental factors as well as geographical factors to advanced analytics output that may contribute to a potential disaster and subsequently taking necessary precautionary measures to avoid such disaster.

32. The method as claimed in claim 24, claim 26 and claim 31, wherein a real time train vulnerability profile for each train is computed based on said real time train data and said real-time geographical and environmental data wherein said train vulnerability profile is constantly updated depending upon variations in the parameters constituting said real time train data and said real-time geographical and environmental data.

33. The method as claimed in claim 24, claim 28 and claim 32, wherein said degree of disaster vulnerability by central command control computation system is computed by collective analysis of said centralised analytics, said real time train vulnerability profile and said real time passenger vulnerability profile.

34. The method as claimed in claim 24, wherein in case degree of disaster vulnerability from collective analysis of centralized analytics is below said predetermined threshold value, the output from said centralized analytics is also sent to emergency maintenance requirement system for rectification of the detected abnormality in the rail route whereby ensuring complete safety of the rail route for future train runs.

35. The method as claimed in claim 24, wherein while triggering said disaster alert, the potential disaster scenarios along with associated impacts are communicated immediately to Control Guidance System inside said train and other respective trains in said railway network whereby avoiding further damage to the trains passing through or near the disaster location.

36. The method as claimed in claim 24, wherein while computing said degree of disaster vulnerability, real time train vulnerability profile and real time passenger vulnerability profile is also taken into consideration whereby the system can immediately estimate the necessary precautionary measures to avoid the potential accident or disaster.

37. The method as claimed in claim 24, wherein upon receiving said disaster alert, said Control Guidance System inside the train automatically transmits alerts to various disaster management agencies of the potential disaster event along with disaster characteristics to enable said disaster management agencies employ appropriate and timely rescue and evacuation operations based on the assessment of the disaster vulnerability.

38. The method as claimed in claim 24, wherein in case in case degree of disaster vulnerability exceeds threshold value, control zones are computed based on impact assessment of disaster vulnerability at different locations on the railway route for providing guidance to avoid and minimize the disaster impact.

39. The method as claimed in claim 38, wherein based on said control zones, said system automatically and dynamically updates the information, including location profile and nature of impending disaster, across all the rail routes in order to alert other trains of the disaster.

40. The method as claimed in claim 24, wherein said Onboard Disaster Rescue and Recovery System activates Response Rescue Functions based on the output from said control zones wherein said Response Rescue Functions further comprise at least one of:
a. application of collision impact reduction buffering system in the train for reducing the impact of sudden break and reducing the harm to the passengers;
b. announcement of the mishappening in all the compartments whereby alerting passengers of the accident and help them take action to rescue themselves;
c. shutting down of the electrical systems inside the train for prevention of fire due to shortcut;
d. activation of infant protection system;
e. automatic breakage of train windows for easy exit from the train;
f. automatic release of emergency outlets for immediate rescue of the passengers from the train;
g. activation of anti skidding friction system inside the train;
h. deployment of air bags for prevention of damage to the passengers from sudden break or movement of train;
i. activation of fire extinguishing system to prevent damage caused due to fire inside the train;
j. application of collision impact reduction system to prevent and reduce damage due to sudden collision;
k. release of first aid kit for providing immediate first aid to wounded passengers.
